(19) United States
(12) Patent Application Publication
(10) Pub. No.: US 2024/0405826 A1
(43) Pub. Date: Dec. 5, 2024

(54) APERIODIC CHANNEL STATE INFORMATION REPORTING FOR DYNAMIC BASE STATION ANTENNA PORT ADAPTATION

(71) Applicant: QUALCOMM INCORPORATED, San Diego, CA (US)

(72) Inventors: Hung Dinh Ly, San Diego, CA (US); Yu Zhang, San Diego, CA (US); Kexin Xiao, Shanghai (CN)

(21) Appl. No.: 18/694,331

(22) PCT Filed: Nov. 30, 2021
(86) PCT No.: PCT/CN2021/134225

§ 371 Date: Mar. 21, 2024

(51) Int. Cl. H04B 7/06; H04L 1/00; H04L 5/00; H04W 24/10; H04W 52/02

(52) U.S. Cl. CPC H04B 7/0626; H04L 1/0026; H04L 5/0051; H04W 24/10; H04W 52/0206

(57) ABSTRACT

Methods, systems, and devices for wireless communications are described. A user equipment (UE) may receive, from a base station, first control signaling configuring multiple aperiodic channel state information (A-CSI) trigger states including at least a first trigger state for a first power mode and a second trigger state for a second power mode. The UE may receive second control signaling indicating a trigger state of the multiple A-CSI trigger states. The UE may determine a current power mode of the network based on the indicated trigger state. In some examples, the UE may receive third control signaling indicating a subset of the multiple A-CSI trigger states, and the second control signaling may indicate one trigger state from the subset of A-CSI trigger states. The UE may transmit a channel state information (CSI) report based on the indicated trigger state and the current power mode of the network.

### CROSS REFERENCE

The present application is a 371 national stage filing of International PCT Application No. PCT/CN2021/134225 by Ly et al. entitled “APERIODIC CHANNEL STATE INFORMATION REPORTING FOR DYNAMIC BASE STATION ANTENNA PORT ADAPTATION,” filed Nov. 30, 2021, which is assigned to the assignee hereof, and which is expressly incorporated by reference in its entirety herein.

### FIELD OF TECHNOLOGY

The following relates to wireless communications, including aperiodic channel state information (A-CSI) reporting for dynamic base station antenna port adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support dynamic antenna port adaptation and channel state information (CSI) reporting. For example, a base station may include a quantity of antenna ports, which may consume power. In some cases, the base station may disable or deactivate one or more antenna ports based one or more factors associated with the network. Additionally, a UE may perform CSI measurement and reporting procedures, which may be implemented to evaluate the availability and quality of wireless communication channels. The base station and the UE may communicate CSI signaling (e.g., CSI reference signals (CSI-RSs) and CSI reports) periodically or aperiodically (e.g., dynamically). However, the CSI signaling may depend on the current antenna port configuration at the base station. In some cases, dynamic antenna port adaptation may cause misalignment between the CSI reporting and the current antenna port configuration, potentially reducing communication reliability between the UE and the base station.

### SUMMARY

The described techniques relate to improved methods, systems, devices, and apparatuses that support aperiodic channel state information (A-CSI) reporting for dynamic base station antenna port adaptation. Generally, the described techniques provide for a user equipment (UE) and base station to align channel state information (CSI) reporting with a current dynamic antenna port configuration at the base station based on a current network power mode. The UE may receive, from a base station, control signaling (e.g., radio resource control (RRC) signaling) configuring a set of multiple A-CSI trigger states. Some different trigger states of the set of multiple A-CSI trigger states may correspond to different network power modes. For example, at least a first trigger state may indicate a first network power mode and a second trigger state may indicate a second network power mode different from the first network power mode. The base station may operate according to a current network power mode and may indicate a trigger state to the UE based on the base station's current network power mode. In some cases, the UE may receive, from the base station, control signaling (e.g., a medium access control (MAC) control element (CE)) indicating a subset of the set of multiple A-CSI trigger states. The UE may additionally or alternatively receive, from the base station, control signaling (e.g., downlink control information (DCI)) indicating a trigger state of the set of multiple A-CSI trigger states or of the subset of the set of multiple A-CSI trigger states (e.g., if the MAC-CE was received configuring the subset). The indicated trigger state may indicate—to the UE-a current network power mode of the base station. The UE may transmit, to the base station, a channel state information (CSI) report based on the indicated trigger state and the current network power mode of the base station.

A method for wireless communications at a UE is described. The method may include receiving, from a base station, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, receiving, from the base station, second control signaling indicating a trigger state of the set of multiple aperiodic channel state information trigger states, the indicated trigger state further indicating a current network power mode of the base station, and transmitting, to the base station, a channel state information report based on the indicated trigger state and the current network power mode of the base station.

An apparatus for wireless communications at a UE is described. The apparatus may include a processor, memory coupled with the processor, and instructions stored in the memory. The instructions may be executable by the processor to cause the apparatus to receive, from a base station, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, receive, from the base station, second control signaling indicating a trigger state of the set of multiple aperiodic channel state information trigger states, the indicated trigger state further indicating a current network power mode of the base station, and transmit, to the base station, a channel state information report based on the indicated trigger state and the current network power mode of the base station.

Another apparatus for wireless communications at a UE is described. The apparatus may include means for receiving, from a base station, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, means for receiving, from the base station, second control signaling indicating a trigger state of the set of multiple aperiodic channel state information trigger states, the indicated trigger state further indicating a current network power mode of the base station, and means for transmitting, to the base station, a channel state information report based on the indicated trigger state and the current network power mode of the base station.

A non-transitory computer-readable medium storing code for wireless communications at a UE is described. The code may include instructions executable by a processor to receive, from a base station, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, receive, from the base station, second control signaling indicating a trigger state of the set of multiple aperiodic channel state information trigger states, the indicated trigger state further indicating a current network power mode of the base station, and transmit, to the base station, a channel state information report based on the indicated trigger state and the current network power mode of the base station.

Some examples of the method, apparatuses, and non-transitory computer-readable medium described herein may further include operations, features, means, or instructions for determining the current network power mode of the base station in response to receiving the second control signaling indicating the trigger state.

Some examples of the method, apparatuses, and non-transitory computer-readable medium described herein may further include operations, features, means, or instructions for determining a quantity of antenna ports active at the base station based on the current network power mode of the base station, where the channel state information report may be based on the quantity of the antenna ports active at the base station.

In some examples of the method, apparatuses, and non-transitory computer-readable medium described herein, the antenna ports active at the base station include a subset of antenna ports of the base station based on the current network power mode corresponding to a lower power than a normal network power mode of the base station.

Some examples of the method, apparatuses, and non-transitory computer-readable medium described herein may further include operations, features, means, or instructions for receiving, from the base station, third control signaling indicating a subset of the set of multiple aperiodic channel state information trigger states, where the second control signaling indicates the trigger state from the subset of the set of multiple aperiodic channel state information trigger states.

Some examples of the method, apparatuses, and non-transitory computer-readable medium described herein may further include operations, features, means, or instructions for determining the subset of the set of multiple aperiodic channel state information trigger states based on a bit field of the third control signaling, where each trigger state of the set of multiple aperiodic channel state information trigger states corresponds to a respective bit of the bit field.

In some examples of the method, apparatuses, and non-transitory computer-readable medium described herein, a first set of multiple bits of the bit field correspond to a first set of multiple trigger states of the set of multiple aperiodic channel state information trigger states corresponding to a normal network power mode and a second set of multiple bits of the bit field correspond to a second set of multiple trigger states of the set of multiple aperiodic channel state information trigger states corresponding to one or more network power modes different from the normal network power mode.

In some examples of the method, apparatuses, and non-transitory computer-readable medium described herein, the subset of the set of multiple aperiodic channel state information trigger states includes at least the first trigger state corresponding to the first network power mode and the second trigger state corresponding to the second network power mode.

In some examples of the method, apparatuses, and non-transitory computer-readable medium described herein, the third control signaling includes a medium access control element.

In some examples of the method, apparatuses, and non-transitory computer-readable medium described herein, the first control signaling includes radio resource control signaling and the second control signaling includes downlink control information.

In some examples of the method, apparatuses, and non-transitory computer-readable medium described herein, the current network power mode of the base station includes a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

Some examples of the method, apparatuses, and non-transitory computer-readable medium described herein may further include operations, features, means, or instructions for determining one or more report configurations based on the indicated trigger state, determining one or more channel state information reference signal resource settings active for the one or more report configurations, determining one or more channel state information reference signal resource sets configured for the one or more channel state information reference signal resource settings, and selecting one or more channel state information reference signal resources of the one or more channel state information reference signal resource sets, where the channel state information report includes a channel state information reference signal resource indicator indicating the selected one or more channel state information reference signal resources.

Some examples of the method, apparatuses, and non-transitory computer-readable medium described herein may further include operations, features, means, or instructions for measuring channel state information using the selected one or more channel state information reference signal resources, where the channel state information report indicates the measured channel state information.

A method for wireless communications at a base station is described. The method may include transmitting, to a UE, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, operating according to a current network power mode, transmitting, to the UE, second control signaling indicating a trigger state of the set of multiple aperiodic channel state information trigger states, the indicated trigger state further indicating the current network power mode, and receiving, from the UE, a channel state information report based on the indicated trigger state and the current network power mode.

An apparatus for wireless communications at a base station is described. The apparatus may include a processor, memory coupled with the processor, and instructions stored in the memory. The instructions may be executable by the processor to cause the apparatus to transmit, to a UE, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, operate according to a current network power mode, transmit, to the UE, second control signaling indicating a trigger state of the set of multiple aperiodic channel state information trigger states, the indicated trigger state further indicating the current network power mode, and receive, from the UE, a channel state information report based on the indicated trigger state and the current network power mode.

Another apparatus for wireless communications at a base station is described. The apparatus may include means for transmitting, to a UE, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, means for operating according to a current network power mode, means for transmitting, to the UE, second control signaling indicating a trigger state of the set of multiple aperiodic channel state information trigger states, the indicated trigger state further indicating the current network power mode, and means for receiving, from the UE, a channel state information report based on the indicated trigger state and the current network power mode.

A non-transitory computer-readable medium storing code for wireless communications at a base station is described. The code may include instructions executable by a processor to transmit, to a UE, first control signaling configuring a set of multiple aperiodic channel state information trigger states, the set of multiple aperiodic channel state information trigger states including at least a first trigger state corresponding to a first network power mode and a second trigger state corresponding to a second network power mode different from the first network power mode, operate according to a current network power mode, transmit, to the UE, second control signaling indicating a trigger state of the set of multiple aperiodic channel state information trigger states, the indicated trigger state further indicating the current network power mode, and receive, from the UE, a channel state information report based on the indicated trigger state and the current network power mode.

In some examples of the method, apparatuses, and non-transitory computer-readable medium described herein, operating according to the current network power mode may include operations, features, means, or instructions for deactivating a subset of antenna ports, a subset of antenna sub-panels, a subset of antenna panels, or any combination thereof and communicating with the UE based on the deactivating.

In some examples of the method, apparatuses, and non-transitory computer-readable medium described herein, the indicated trigger state further indicates the deactivated subset of antenna ports, the deactivated subset of antenna sub-panels, the deactivated subset of antenna panels, or any combination thereof.

Some examples of the method, apparatuses, and non-transitory computer-readable medium described herein may further include operations, features, means, or instructions for transmitting, to the UE, third control signaling indicating a subset of the set of multiple aperiodic channel state information trigger states, where the second control signaling indicates the trigger state from the subset of the set of multiple aperiodic channel state information trigger states.

Some examples of the method, apparatuses, and non-transitory computer-readable medium described herein may further include operations, features, means, or instructions for generating a bit field for the third control signaling, where each trigger state of the set of multiple aperiodic channel state information trigger states corresponds to a respective bit of the bit field and setting bit values of the bit field to indicate the subset of the set of multiple aperiodic channel state information trigger states.

In some examples of the method, apparatuses, and non-transitory computer-readable medium described herein, a first set of multiple bits of the bit field correspond to a first set of multiple trigger states of the set of multiple aperiodic channel state information trigger states corresponding to a normal network power mode and a second set of multiple bits of the bit field correspond to a second set of multiple trigger states of the set of multiple aperiodic channel state information trigger states corresponding to one or more network power modes different from the normal network power mode.

In some examples of the method, apparatuses, and non-transitory computer-readable medium described herein, the subset of the set of multiple aperiodic channel state information trigger states includes at least the first trigger state corresponding to the first network power mode and the second trigger state corresponding to the second network power mode.

In some examples of the method, apparatuses, and non-transitory computer-readable medium described herein, the third control signaling includes a medium access control element.

In some examples of the method, apparatuses, and non-transitory computer-readable medium described herein, the first control signaling includes radio resource control signaling and the second control signaling includes downlink control information.

In some examples of the method, apparatuses, and non-transitory computer-readable medium described herein, the current network power mode includes a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

### BRIEF DESCRIPTION OF THE DRAWINGS

FIGS. 1 and 2 illustrate examples of wireless communications systems that support aperiodic channel state information (A-CSI) reporting for dynamic base station antenna port adaptation in accordance with aspects of the present disclosure.

FIG. 3 illustrates an example of a resource configuration that supports A-CSI reporting for dynamic base station antenna port adaptation in accordance with aspects of the present disclosure.

FIG. 4 illustrates an example of a process flow that supports A-CSI reporting for dynamic base station antenna port adaptation in accordance with aspects of the present disclosure.

FIGS. 5 and 6 show block diagrams of devices that support A-CSI reporting for dynamic base station antenna port adaptation in accordance with aspects of the present disclosure.

FIG. 7 shows a block diagram of a communications manager that supports A-CSI reporting for dynamic base station antenna port adaptation in accordance with aspects of the present disclosure.

FIG. 8 shows a diagram of a system including a device that supports A-CSI reporting for dynamic base station antenna port adaptation in accordance with aspects of the present disclosure.

FIGS. 9 and 10 show block diagrams of devices that support A-CSI reporting for dynamic base station antenna port adaptation in accordance with aspects of the present disclosure.

FIG. 11 shows a block diagram of a communications manager that supports A-CSI reporting for dynamic base station antenna port adaptation in accordance with aspects of the present disclosure.

FIG. 12 shows a diagram of a system including a device that supports A-CSI reporting for dynamic base station antenna port adaptation in accordance with aspects of the present disclosure.

FIGS. 13 through 16 show flowcharts illustrating methods that support A-CSI reporting for dynamic base station antenna port adaptation in accordance with aspects of the present disclosure.

### DETAILED DESCRIPTION

In some wireless communications systems, base stations may consume significantly more power than other network entities, such as data centers, switching components, and core transmission components. Additionally, some base stations (e.g., in fifth generation (5G) networks or other networks) may implement relatively large quantities of antenna panels (e.g., massive multiple-input multiple-output (MIMO) antenna panels including quantities of antenna ports exceeding a threshold quantity), which may result in additional power consumption as compared to base stations with fewer antenna panels. For example, an antenna panel may be equipped with multiple power amplifiers (PA) and antenna subsystems, which may consume a relatively large amount of power (e.g., a significant proportion of the network's power consumption). In some cases, further increased power consumption may result from operating using relatively higher frequencies, larger bandwidths, larger quantities of transceivers, or any combination thereof by wireless network entities (e.g., base stations in 5G networks). Some wireless communications systems may use methods to reduce power consumption by dynamically disabling (e.g., turning off) a quantity of antenna panels (e.g., corresponding to a quantity of logical antenna ports) for specific time periods. For example, a base station may operate in a network power saving mode by deactivating one or more antenna ports at the base station, effectively lowering the power overhead at the base station.

In some cases, a base station and a UE may communicate signaling associated with channel state information (CSI) reporting to evaluate the availability and quality of a wireless communication channel. The base station and the UE may transmit CSI signaling periodically or aperiodically (e.g., dynamically). For aperiodic CSI (A-CSI) reporting, the base station may request a CSI report from the UE. For example, the base station may transmit downlink control information (DCI) to the UE that includes an indication of an A-CSI trigger state. The A-CSI trigger state may trigger the UE to measure one or more CSI reference signals (RSs) and transmit a CSI report to the base station based on the measurements. In some cases, A-CSI resources and corresponding A-CSI trigger states may be associated with one or more antenna ports (e.g., one or more antenna panels corresponding to one or more antenna ports) active at the base station. Accordingly, the UE may receive an indication of an A-CSI trigger state for one or more antenna panels, which may be currently enabled or disabled at the base station. However, in some cases, the UE may fail to determine the current network power mode of the base station and, correspondingly, may fail to determine whether a corresponding antenna panel is currently enabled or disabled at the base station.

In accordance with the techniques described herein, one or more A-CSI trigger states may be configured to indicate a current network power mode. For example, some A-CSI trigger states may implicitly correspond to a normal network power mode (e.g., in which all antenna ports are active at a base station). Further, the base station may configure additional A-CSI trigger states that correspond to different network power modes (e.g., a high network power mode, a low network power mode, a medium network power mode, or any other network power modes or power saving configurations). In some cases, the high network power mode may be referred to as a normal network power mode, and the medium network power mode and the low network power mode may be referred to as network power saving modes. In some cases, a UE may receive DCI indicating an A-CSI trigger state corresponding to a specific network power mode. The UE may determine a current network power mode for the network based on the indicated A-CSI trigger state. Accordingly, the UE may measure CSI-RSs and transmit a CSI report to the base station based on the current network power mode. For example, the UE may transmit a CSI report to the base station including CSI for active antenna panels (e.g., corresponding to active antenna ports) configured based on the network power mode according to which the base station is currently operating. That is, the UE may determine not to include CSI for inactive or disabled antenna panels or antenna ports based on the indicated A-CSI trigger state and the corresponding current network power mode.

The wireless communications system may additionally support a medium access control (MAC) control element (CE) configuration, which may include resources for indicating A-CSI trigger states corresponding to the normal network power mode, one or more network power saving modes, or both. For example, a base station may transmit radio resource control (RRC) signaling to the UE configuring the UE with a set of multiple A-CSI trigger states and may transmit a MAC-CE (e.g., an A-CSI trigger state sub-selection MAC-CE) selecting a subset of the multiple A-CSI trigger states for the UE. The base station may transmit DCI to indicate an A-CSI trigger state from the MAC-CE-configured subset for the UE to use for CSI reporting. In some examples, the MAC-CE may configure the UE with a mixture of one or more A-CSI trigger states associated with one or more network power saving modes and one or more A-CSI trigger states associated with a normal (e.g., default) network power mode. In some cases, the A-CSI trigger states associated with the power saving modes may indicate a quantity of antenna ports that are enabled or disabled at the base station. The UE may use the A-CSI trigger state indication to both trigger CSI reporting and determine the current network power mode for the base station.

Aspects of the disclosure are initially described in the context of wireless communications systems. Aspects of the disclosure are further illustrated by and described with reference to resource configurations, process flows, apparatus diagrams, system diagrams, and flowcharts that relate to A-CSI reporting for dynamic base station antenna port adaptation.

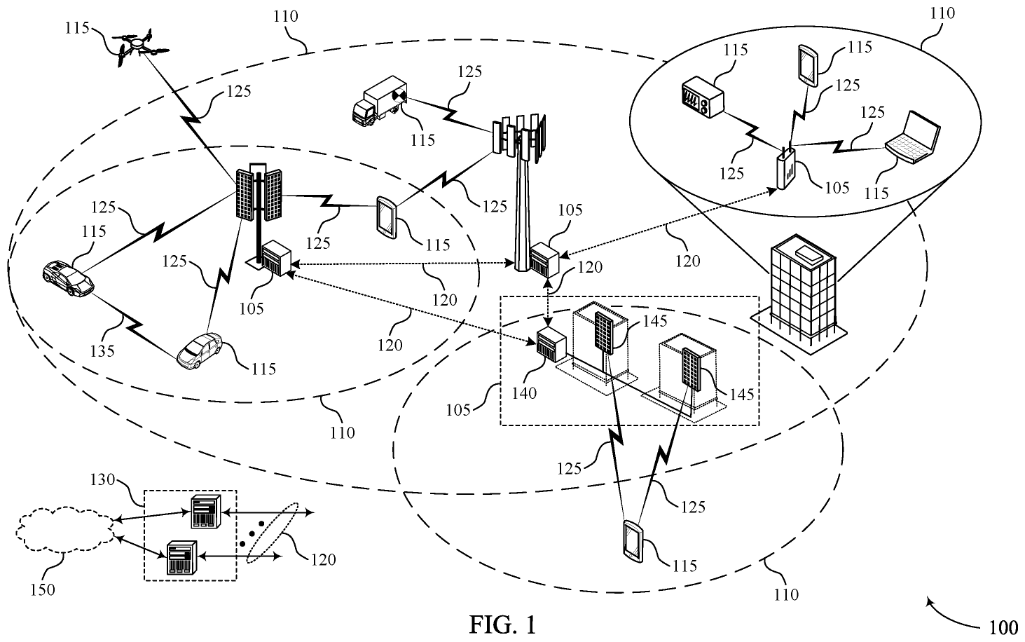

FIG. 1 illustrates an example of a wireless communications system 100 that supports A-CSI reporting for dynamic base station antenna port adaptation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of TS=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, MIMO communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may use a precoding matrix indicator (PMI) to report preferred precoding for downlink transmissions. In some cases, the UE 115 may transmit the PMI to a base station to indicate preferred precoding for MIMO communications. In some examples, the PMI may indicate precoding for both MIMO communications and beamforming configurations. One or more parameters for PMI reporting may be configured by one or more codebooks (e.g., PMI codebooks). In some cases, a UE 115 and a base station 105 may operate according to one or more codebook types for PMI codebook reporting. Codebook types may be associated with various antenna panel configurations (e.g., Type I single panel codebook, Type I multiple panels codebook, Type II single panel codebook, Type II port selection codebook, Type II enhanced port selection codebook).

A specific PMI codebook type may include supported configurations for antenna elements (e.g., corresponding to specific antenna port configurations), which may correspond to a quantity of CSI-RS antenna ports. For example, a quantity of CSI-RS antenna ports (P_{CSI-RS}), a configuration of antenna elements associated with a first number of elements (N₁) (e.g., antenna elements in a row of an antenna panel), and a configuration of antenna elements associated with a second number of elements (N₂) (e.g., antenna elements in a column of the antenna panel) may be defined by a first table, such as Table 1. The first table may be associated with supported configurations for antenna elements corresponding to one or more codebook types.

TABLE 1
Example Supported Antenna Element Configurations

| P_{CSI-RS} | (N₁, N₂) |
|---|---|
| 4 | (2, 1) |
| 8 | (2, 2) |
| | (4, 1) |
| 12 | (3, 2) |
| | (6, 1) |
| 16 | (4, 2) |
| | (8, 1) |
| 24 | (4, 3) |
| | (6, 2) |
| | (12, 1) |
| 32 | (4, 4) |
| | (8, 2) |
| | (16, 1) |

Similarly, a quantity of CSI-RS antenna ports, P_{CSI-RS}, a number of antenna panels (N_{g}) at a base station 105, the first number of elements, N₁, and the second number of elements, N₂, may be defined by a second table, Table 2. The second table may additionally be associated with supported configurations for antenna elements corresponding to one or more codebook types.

TABLE 2
Example Supported Antenna Panel Configurations

| P_{CSI-RS} | (N_{g}, N₁, N₂) |
|---|---|
| 8 | (2, 2, 1) |
| 16 | (2, 4, 1) |
| | (4, 2, 1) |
| | (2, 2, 2) |
| 32 | (2, 8, 1) |
| | (4, 4, 1) |
| | (2, 4, 2) |
| | (4, 2, 2) |

However, the specific configuration may further depend on the current active antenna ports of the base station 105, which may depend on a current network power mode. For example, deactivating one or more antenna panels may affect the value of N_{g}, while deactivating one or more antenna elements or antenna ports of an antenna panel may affect, N₁, N₂, or both. The number of CSI-RS antenna ports per resource may be calculated according to Equation 1, where the value “2” is based on each antenna element corresponding to two logical antenna ports.

$$Number of CSI - RS Antenna Ports = 2 {N}_{g} {N}_{1} {N}_{2} \qquad ( 1 )$$

A UE 115 may report CSI based on a CSI-RS configuration. For example, the UE 115 may report CSI for a single TRP based on a CSI report configuration. The CSI report configuration may be associated with one or more frameworks. The CSI report configuration may be used by a UE 115 to generate a CSI report for a base station 105. The CSI report configuration may include one or more links to one or more resource settings. In some cases, the CSI report configuration may have a link to a channel measurement resource (CMR) resource setting. In some cases, the CSI report configuration may indicate the CMR resource setting as well as either a CSI interference measurement (IM) resource setting or a non-zero power (NZP) interference management resource (IMR) resource setting. In some cases, the CSI report configuration may have a link to the CMR resource setting, the CSI-IM resource setting, and the NZP-IMR resource setting.

A resource setting may include an active resource set. In some cases, the CMR resource setting may include or otherwise indicate multiple CMR resource sets, in which a CMR resource set n is activated. The CSI-IM resource setting may include multiple CSI-IM resource sets in which a CSI-IM resource set m is activated, and the NZP-IMR resource setting may include multiple NZP-IMR resource sets in which an NZP-IMR resource set s is activated. Each of the resource sets associated with the CSI report configuration (e.g., CMR resource set n, CSI-IM resource set m, NZP-IMR resource set s, or a combination thereof) may include one or more resources (e.g., N number of CSI-RS resources). The UE 115 may evaluate the CSI report configuration and may select at least one CMR resource out of the N resources included in the CMR resource set n. Each CMR resource may have an associated CSI-IM resource and may be collectively associated with all NZP resources from the activated NZP-IMR resource set. For example, if the UE 115 selects an NZP CMR resource n1, it may also select a CSI-IM resource m1 and all NZP-IMR resources from NZP-IMR resource set s. If the UE 115 selects an NZP CMR resource n2, it may also select a CSI-IM resource m2 and all NZP-IMR resources from NZP-IMR resource set s. The UE 115 may include a channel resource indication (CRI) in the CSI report to indicate to the base station which NZP CMR resource was used to generate the CSI report.

A UE 115 may report aperiodic CSI (A-CSI) based on a request from a base station 105. For example, the UE 115 may transmit A-CSI to the base station 105 based on one or more trigger states. Each trigger state may be associated with one or more report configurations (e.g., ReportConfig), where each report configuration is associated with one or more resource settings (e.g., persistent (P) resource settings, semi-persistent (SP) resource settings, aperiodic (AP) resource settings). If a resource setting linked to a report configuration has multiple aperiodic resource sets and a subset of the aperiodic resource sets is associated with the trigger state, the base station 105 may configure a bitmap in radio resource control (RRC) signaling per trigger state per resource setting to indicate selection of CSI-IM/NZP CSI-RS resource sets from the resource setting. In some cases, the bitmap may have a bit width (N_{bit}) that may be equal to a number of resource sets in a resource setting.

Using such techniques, a base station 105 may trigger a UE 115 to transmit an A-CSI report (e.g., based on a specific trigger state). The UE 115 may measure CSI for one or more CSI-RSs in one or more configured resources (e.g., CMR resources, CSI-IM resources, NZP-IMR resources, or any combination thereof) and may generate a CSI report based on the measurements. For example, the CSI report may include a channel quality indicator (CQI), a PMI, a CRI, a synchronization signal (SS)/physical broadcast channel (PBCH) resource block indicator (SSBRI), a layer indicator (LI), a rank indicator (RI), or any combination of these or other measurements or parameters. The UE 115 may transmit the CSI report to the base station 105 in response to the trigger state, and the base station 105, the UE 115, or both may use the reported CSI to select one or more communication parameters for communication between the base station 105 and the UE 115. For example, the base station 105 may determine precoding, a transmission power, spatial multiplexing, or some combination of these or other parameters based on the reported CSI. However, the current network power mode for the base station 105—and, correspondingly, the currently active antenna ports, antenna elements, antenna panels, or combination thereof—may affect the resources for CSI reporting.

Various aspects of the present disclosure relate to a base station 105 configuring (e.g., via RRC signaling) one or more A-CSI trigger states to indicate a network power mode. The base station 105 may configure additional A-CSI trigger states that correspond to various network power modes such as normal network power modes and power saving network power modes. In some cases, a UE 115 may receive DCI indicating one or more A-CSI trigger states corresponding to one or more network power modes. Additionally or alternatively, the UE 115 may receive a MAC-CE indicating one or more A-CSI trigger states corresponding to one or more network power modes. The UE 115 may determine a current network power mode based on the indicated one or more A-CSI trigger states. Accordingly, the UE 115 may transmit a CSI report to the base station 105 based on the current network power mode. For example, the UE 115 may transmit a CSI report to the base station 105 based on the resources for CSI reporting corresponding to the active antenna panels or active antenna ports for the indicated current network power mode.

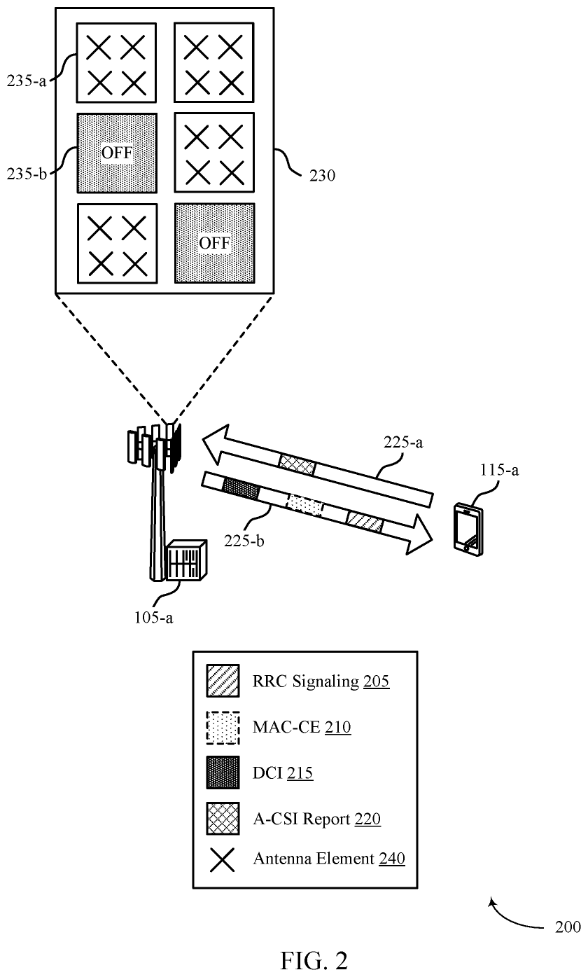

FIG. 2 illustrates an example of a wireless communications system 200 that supports A-CSI reporting for dynamic base station antenna port adaptation in accordance with aspects of the present disclosure. The wireless communications system 200 may implement aspects of the wireless communications system 100. For example, the wireless communications system 200 may include a base station 105-a and a UE 115-a, which may be examples of a corresponding base station 105 and UE 115 as described with reference to FIG. 1. In some cases, the base station 105-a and the UE 115-a may communicate over communication links, which may be examples of communication links 125 as described with reference to FIG. 1. For example, the UE 115-a may transmit information to the base station 105-a over one or more uplink channels 225-a, and the base station 105-a may transmit information to the UE 115-a over one or more downlink channels 225-b.

The base station 105-a may include one or more antenna arrays 230. In some examples, an antenna array 230 may correspond to a TRP at the base station 105-a. Each antenna array 230 may include multiple antenna panels 235, and each antenna panel 235 may include multiple antennas (e.g., antenna elements 240). In some cases, a physical antenna element 240 may correspond to one or more logical antenna ports (e.g., two antenna ports). In some cases, the base station 105-a may use the antenna ports to employ MIMO communications or beamforming. In some cases, the antenna array 230 may be co-located at an antenna assembly, such as an antenna tower. In some cases, the UE 115-a may additionally include one or more antennas, which may support various MIMO or beamforming operations.

A wireless device (e.g., the base station 105-a or the UE 115-a) may use MIMO communications to propagate spatially-multiplexed signaling. For example, different spatial layers may be associated with different antennas (e.g., different antenna ports, different antenna elements 240, or both). The wireless device may transmit or receive communications using MIMO techniques such as single-user MIMO (SU-MIMO), where multiple spatial layers are used for transmissions to the same receiving device, and multiple-user MIMO (MU-MIMO), where multiple spatial layers are used for transmissions to multiple devices. In some cases, the base station 105-a may transmit DCI 215 to the UE 115-a using MIMO communications. The base station 105-a may additionally or alternatively transmit one or more MAC-CEs 210 to the UE 115-a using MIMO communications. In some cases, the UE 115-a may transmit an A-CSI report 220 to the base station 105-a using MIMO communications.

The base station 105-a and the UE 115-a may perform CSI reporting procedures to evaluate the availability, quality, or both of a wireless communication channel. For example, the UE 115-a may receive one or more reference signals, such as one or more CSI-RSs, from the base station 105-a. The UE 115-a may determine CSI based on measurements associated with the one or more reference signals. The UE 115-a may generate a CSI report and may transmit the CSI report to the base station 105-a. In some cases, the base station 105-a may determine to communicate with the UE 115-a over a wireless channel based on the CSI report. The CSI report may include one or more measurements associated with one or more reference signals.

In some cases, the base station 105-a and the UE 115-a may perform CSI reporting procedures periodically (e.g., at configured time intervals). For example, the base station 105-a may periodically transmit CSI-RSs to the UE 115-a, and the UE 115-a may periodically transmit CSI reports to the base station 105-a. In some other cases, the base station 105-a and the UE 115-a may transmit CSI reporting signals aperiodically (e.g., dynamically). For example, the base station 105-a may trigger an A-CSI report 220 using DCI 215 signaling, RRC signaling 205, MAC-CE 210 signaling, or some combination of this signaling. For example, the base station 105-a may transmit the DCI 215 to the UE 115-a, where the DCI 215 may include an indication requesting an A-CSI report 220. The UE 115-a may perform CSI-RS measurements and transmit the A-CSI report 220 to the base station 105-a based on receiving the DCI 215.

Some wireless communications systems 200 (e.g., NR networks) may support an increased quantity of antenna arrays 230 per base station 105-a as compared to other wireless networks (e.g., LTE networks), which may support increased throughput for the base station 105-a. In some cases, the supported quantity of antenna arrays 230 may be referred to as massive MIMO. In some cases, the base station 105-a may be an example of a base station 105 that supports massive MIMO communications. For example, the base station 105-a may include a relatively large quantity of antenna arrays 230, antenna panels 235, antenna elements 240, or a combination thereof. However, antenna arrays 230 may consume a relatively large percentage of a total power consumption associated with the base station 105-a. Additionally, the base station 105-a may consume a relatively large percentage of a total power consumption associated with a wireless network that includes the base station 105-a. As a result, inefficiencies associated with the operation of antenna arrays 230 may result in significant operating expenses and carbon emissions, for example, as compared to other power-consuming entities within the wireless network.

In a specific example, the base station 105-a may be an example of a base station 105 associated with a 5G network. In some cases, power consumption associated with a base station 105-a operating in a 5G network may be approximately three times higher than a base station operating in an LTE network. In some cases, one or more active antenna units (AAUs) may consume a relatively large percentage (e.g., approximately 90%) of power consumption of a base station 105-a operating in a 5G network. In some cases, the increased power consumption of 5G base stations may be the result of operating according to higher frequencies, larger bandwidths, and large quantities of transceivers as compared to other base stations, such as LTE base stations. In some cases, base stations 105 associated with a wireless network may account for approximately 20% of operating costs associated with the wireless network. As such, power saving techniques used at base stations 105 may significantly improve operating costs for a wireless network.

In some cases, the base station 105-a may perform one or more power-saving techniques, which may include disabling one or more antenna ports, antenna elements 240, antenna panels 235, antenna subpanels, or antenna arrays 230. For example, the base station 105-a may disable one or more antenna panels 235 of the antenna array 230, such as the antenna panel 235-b, based on network information. The base station 105-a may operate using a subset of the total set of antenna panels 235 configured at the base station 105-a, for example, including an active antenna panel 235-a. In some cases, the base station 105-a may dynamically disable one or more antenna panels 235 of the antenna array 230. For example, the base station 105-a may determine to disable one or more antenna panels 235 of the antenna array 230 based on the occurrence of an event or a trigger condition, which may be referred to as dynamic antenna port adaptation. In some examples, the base station 105-a may activate or deactivate an antenna panel 235 or another configuration of antenna elements 240 or antenna ports based on a power threshold, a threshold quantity of UEs 115 communicating with the base station 105-a, or some other threshold.

In some cases, A-CSI reporting may be triggered by one or more A-CSI trigger states. For example, the base station 105-a may transmit control signaling to the UE 115-a, which may include one or more of DCI 215 signaling, RRC signaling 205, and MAC-CE 210 signaling. However, in some cases, the A-CSI trigger state reporting framework may not include a sufficient quantity of resources for indicating both the A-CSI trigger state and whether a corresponding antenna panel 235 is enabled or disabled due to a current network power mode. For example, the control signaling indicating the A-CSI trigger state (e.g., DCI 215) may not have a sufficient payload to configure and indicate both the A-CSI trigger state and whether the corresponding antenna panel is enabled or disabled. In such cases, a UE may use improper resources for measuring CSI due to one or more antenna panels 235 being deactivated, resulting in inaccurate CSI reporting and inefficient communications between a base station and the UE. In contrast, as described herein, the wireless communications system 200 may support using one or more A-CSI trigger states to indicate the current network power mode of the base station 105-a. For example, the DCI 215 may indicate an A-CSI trigger state, which may correspond to a specific network power mode and current active antenna configuration at the base station 105-a. The UE 115-a may use the indicated A-CSI trigger state and corresponding network power mode to determine one or more resources for CSI measurements. The UE 115-a may transmit an A-CSI report 220 in response to the A-CSI trigger state and based on the CSI measurements and current network power mode, effectively adapting A-CSI reporting for the UE 115-a to align with dynamic antenna port adaptation at the base station 105-a.

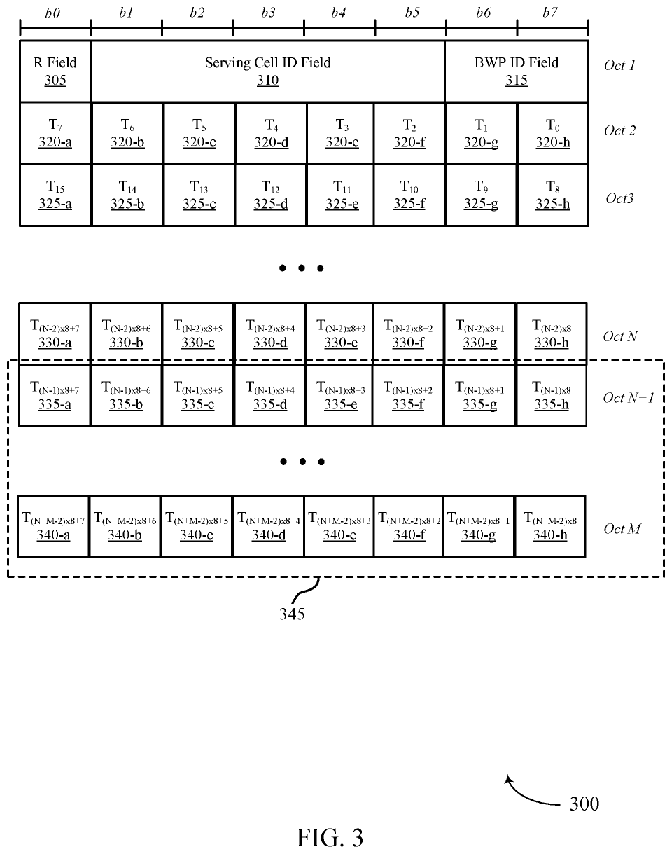

FIG. 3 illustrates an example of a resource configuration 300 that supports A-CSI reporting for dynamic base station antenna port adaptation in accordance with aspects of the present disclosure. The resource configuration 300 may support aspects of the wireless communications system 100 and the wireless communications system 200. For example, the resource configuration 300 may be used for wireless communications between UEs 115 and base stations 105 as described with reference to FIGS. 1 and 2. The resource configuration 300 may define resources for a MAC-CE, such as an A-CSI trigger state sub-selection MAC-CE. In some cases, UEs 115 and base stations 105 may determine one or more A-CSI trigger states based on the resource configuration 300. The resource configuration 300 may include a bitmap having multiple bit fields, including bit fields 320, bit fields 325, bit fields 330, bit fields 335, and bit fields 340. The bit fields may be organized in octets of bits (e.g., b₀, b₁, b₂, b₃, b₄, b₅, b₆, b₇), which may be referred to as Octs. For example, the bitmap may include a first set of bit fields corresponding to Oct 2, Oct 3, up to Oct N and a second set of bit fields corresponding to Oct N+1 up to Oct M. In some cases, the first eight bits (e.g., Oct 1) of the resource configuration 300 may include a reserved bit (R) field 305, a serving cell identifier (ID) field 310, and a BWP ID field 315.

In accordance with the techniques described herein, a base station 105 may configure a UE 115 with one or more A-CSI trigger states, which may correspond to one or more network power modes. In some cases, the base station 105 may configure the UE 115 with one or more A-CSI trigger states via control signaling. For example, the base station 105 may transmit multiple control signals to configure the UE 115. In some cases, the base station 105 may use multiple control signals to configure the UE 115 based on the payload for a single control signal. For example, the base station 105 may transmit DCI to the UE 115 to dynamically indicate a specific A-CSI trigger state. However, the DCI may have a limited payload, such that a specific quantity of bits (e.g., two bits) is available in the DCI for use in indicating an A-CSI trigger state. As such, the base station 105 may be unable to configure the UE 115 with a quantity of A-CSI trigger states using one control signal, such as a DCI message. Further, if the UE 115 is configured with multiple possible A-CSI trigger states exceeding a threshold quantity, the base station 105 may be unable to select between the A-CSI trigger states using one control signal, such as a DCI message. For example, if the DCI includes a two-bit field supporting A-CSI trigger state indication, the DCI may support indicating between up to four A-CSI trigger states. However, the UE 115 may be configured with greater than four possible A-CSI trigger states.

In some cases, the base station 105 may configure the UE 115 with one or more A-CSI trigger states using a first control signal and a second control signal. For example, the base station 105 may configure the UE 115 with one or more A-CSI trigger states using RRC and DCI signaling. In some cases, the base station 105 may use RRC signaling to configure the UE 115 with multiple A-CSI trigger states, and the base station 105 may use DCI signaling to indicate an A-CSI trigger state from the multiple configured A-CSI trigger states. For example, the base station 105 may transmit an RRC message to the UE 115 which may define one or more A-CSI trigger states and may map the one or more A-CSI trigger states to one or more codepoints. The base station 105 may additionally transmit a DCI message to the UE 115, where the DCI message may include one or more codepoints associated with the one or more A-CSI trigger states. For example, the DCI message may include a bit field, where the value of the bit field indicates a codepoint that maps to a codepoint- and correspondingly, an A-CSI trigger state—as configured by the RRC message. Accordingly, the DCI message may indicate one or more A-CSI trigger states configured by the RRC message. The base station 105 may configure a quantity of A-CSI trigger states using a payload of an RRC message, which may be significantly larger than a payload of a DCI message. The base station 105 may use the DCI message to dynamically indicate an A-CSI trigger state from the trigger states configured in RRC signaling.

In some cases, the base station 105 may be unable to map each A-CSI trigger state configured by an RRC message to codepoints of a bit field of a DCI message. For example, a two-bit field in a DCI message may include four codepoints. In some cases, an RRC message may configure greater than four A-CSI trigger states, corresponding to greater than four codepoints. As a result, the base station may be unable to use the DCI signaling to indicate between the A-CSI trigger states configured in the RRC message. In some such cases, the base station 105 may use third control signaling to help indicate a specific A-CSI trigger state. The third control signaling may be associated with a payload larger than the second control signaling. For example, the third control signaling may be a MAC-CE, which may have a greater payload than DCI signaling (but a smaller payload than RRC signaling). In some cases, the base station 105 may transmit a MAC-CE to the UE 115, which may indicate one or more A-CSI trigger states. In some cases, one or more codepoints of the MAC-CE may be mapped to one or more codepoints of the DCI. Additionally or alternatively, one or more codepoints of the MAC-CE may be mapped to one or more codepoints of the RRC message. In some cases, the MAC-CE may indicate a subset of A-CSI trigger states configured by the RRC signaling. For example, the MAC-CE may select a quantity of the A-CSI trigger states configured by RRC signaling to map to codepoints in the bit field of the DCI signaling. In this way, if the DCI signaling supports a two-bit field for indicating an A-CSI trigger state, the base station 105 may configure more than four A-CSI trigger states in RRC signaling, may sub-select up to four A-CSI trigger states in a MAC-CE, and indicate an A-CSI trigger state of the sub-selected trigger states in DCI.

The resource configuration 300 may illustrate resources associated with such a MAC-CE. In some cases, the MAC-CE may indicate one or more A-CSI trigger states of a subset of A-CSI trigger states associated with RRC signaling. Accordingly, the MAC-CE may be referred to as a sub-selection MAC-CE. The sub-selection MAC-CE may be identified by a MAC-CE sub-header. The sub-header may include a logical channel identifier (LCID) that identifies the MAC-CE as an A-CSI trigger state sub-selection MAC-CE. The sub-selection MAC-CE may have a variable size and may include one or more fields as illustrated in FIG. 3. The R field 305 may be an example of a reserved bit. In some cases, the R field 305 may be set to “0.” The serving cell ID field 310 may indicate a serving cell ID of a serving cell (e.g., corresponding to the base station 105). The serving cell ID field 310 may indicate a serving cell for which the MAC-CE applies. In some examples, the serving cell ID field 310 may include 5 bits. The BWP ID field 315 may indicate a BWP associated with the serving cell (e.g., corresponding to the base station 105). The BWP ID field 315 may indicate a downlink BWP for which the MAC-CE applies using a codepoint corresponding to the BWP according to a DCI BWP indicator field. In some examples, the BWP ID field 315 may include 2 bits.

The resource configuration 300 may include a number of bit fields to indicate the sub-selection of A-CSI trigger states (e.g., bit fields 320, bit fields 325, bit fields 330, bit fields 335, and bit fields 340). The bit fields may indicate the activation or deactivation (e.g., the selection status) of one or more A-CSI trigger states, which may be configured within an aperiodicTriggerStateList of RRC signaling. For example, the aperiodicTriggerStateList may include a list of A-CSI trigger states that are RRC-configured. A bit field in the resource configuration 300 may store a bit value indicating whether a corresponding A-CSI trigger state is selected, where a first bit value may indicate that the corresponding A-CSI trigger state is selected and a second bit value may indicate that the corresponding A-CSI trigger state is not selected. For example, the bit field 320-h may store a value associated with a first A-CSI trigger state within the list (e.g., within aperiodicTriggerStateList). Similarly, the bit field 320-g may store a value associated with a second A-CSI trigger state within the list (e.g., within aperiodicTriggerStateList). For example, the bit field 320-h may be set to a first bit value (e.g., “1”), which may indicate that the first A-CSI trigger state within aperiodicTriggerStateList is activated for DCI indication. Alternatively, the bit field 320-h may be set to a second bit value (e.g., “0”), which may indicate that the first A-CSI trigger state within aperiodicTriggerStateList is deactivated for DCI indication.

Additional bit fields in the MAC-CE may also store values associated with A-CSI trigger states within aperiodicTriggerStateList. In some cases, aperiodicTriggerStateList may not include an entry (e.g., a configured A-CSI trigger state) for one or more bit fields in the MAC-CE. For example, one or more entries within aperiodicTriggerStateList may be empty. In such cases, the MAC-CE may ignore the respective bit field (e.g., the base station 105, UE 115, or both may ignore the respective field or use a default value in the respective field). If a bit field in the MAC-CE is set to a first bit value (e.g., “1”), the corresponding A-CSI trigger state configured by RRC signaling may be mapped to a codepoint of a DCI A-CSI request field. The codepoint to which the A-CSI trigger state is mapped may be determined by its ordinal position among the A-CSI trigger states with bit fields set to “1.” That is, the first A-CSI trigger state with a bit field set to “1” may be mapped to a first codepoint value for the DCI field (e.g., “01”). Similarly, a second A-CSI trigger state with a bit field set to “1” may be mapped to a second codepoint value (e.g., “10”), and so on. In some cases, one codepoint value for the DCI field (e.g., “00”) may indicate that the DCI does not request CSI. The MAC-CE may sub-select a quantity of A-CSI trigger states up to a threshold quantity supported by the DCI field, such as up to three A-CSI trigger states for a two-bit DCI field with one codepoint value corresponding to no CSI request. The UE 115 receiving the MAC-CE may use the sub-selection of A-CSI trigger states to interpret the indicated codepoint of a received DCI field and determine an A-CSI trigger state indicated by the base station 105.

The resource configuration 300 may include a first set of bits fields and a second set of bits fields for sub-selecting A-CSI trigger states. In some cases, the first set of bit fields may support compatibility with other wireless communications systems. For example, the resource configuration 300 for a MAC-CE may support operations in NR systems, while the first set of bit fields may support compatibility with LTE systems. As an example, the first set of bit fields may include bit field 320-h, bit field 320-g, bit field 320-f, bit field 320-e, bit field 320-d, bit field 320-c, bit field 320-b, and bit field 320-a in Oct 2, bit field 325-h, bit field 325-g, bit field 325-f, bit field 325-e, bit field 325-d, bit field 325-c, bit field 325-b, and bit field 325-a in Oct 3, up to a set of bits fields (e.g., bit field 330-h, bit field 330-g, bit field 330-f, bit field 330-e, bit field 330-d, bit field 330-c, bit field 330-b, and bit field 330-a) in Oct N.

The second set of bits fields (e.g., corresponding to a bitmap extension 345) may support additionally indicating between different network power modes at the base station 105 using the A-CSI trigger states. As an example, the second set of bit fields may include bit field 335-h, bit field 335-g, bit field 335-f, bit field 335-e, bit field 335-d, bit field 335-c, bit field 335-b, and bit field 335-a in Oct N+1 up to a set of bit fields (e.g., bit field 340-h, bit field 340-g, bit field 340-f, bit field 340-e, bit field 340-d, bit field 340-c, bit field 340-b, and bit field 340-a) in Oct M. The bitmap extension 345 may include a set of bit fields corresponding to both A-CSI trigger states and current network power modes. In some cases, the A-CSI trigger states corresponding to one or more network power modes may be different from A-CSI trigger states associated with bit fields in the first set of bit fields. For example, the first set of bit fields may indicate “legacy” A-CSI trigger states, which may implicitly correspond to a “normal” network power mode (e.g., without any deactivated antenna ports, antenna elements, or antenna panels at the base station 105). In some cases, the bitmap extension 345 may enable a base station 105 to configure A-CSI trigger states corresponding to one or more network power modes without using bit fields for the first set of bit fields, which may be associated with legacy operations (e.g., A-CSI trigger state sub-selection in LTE). Accordingly, the base station 105 may utilize one or more resources of the resource configuration 300 to indicate A-CSI trigger states including “legacy” A-CSI trigger states (e.g., implicitly associated with a normal network power mode), A-CSI trigger states associated with one or more network power saving modes, or a combination thereof. In some examples, as illustrated in FIG. 3, the base station 105 may use a MAC-CE to sub-select between a quantity of configured (e.g., RRC-configured) A-CSI trigger states up to 8M-8, where up to 8N-8 may be “legacy” A-CSI trigger states and up to 8M-8N may be A-CSI trigger states associated with respective network power saving modes.

A UE 115 may receive, from a base station 105, RRC signaling configuring a first set of A-CSI trigger states unassociated with a network power saving mode (e.g., implicitly associated with a normal network power mode) and a second set of A-CSI trigger states associated with one or more network power saving modes. Based on the RRC configuration, the UE 115 may associate each A-CSI trigger state with a specific current network power mode (e.g., either a normal network power mode or a network power saving mode). For example, an A-CSI trigger state may correspond to a normal network power mode, a high network power mode, a medium network power mode, a low network power mode, or any other network power mode. A network power saving mode may indicate one or more antenna ports, antenna elements, antenna panels, or any other configuration of antennas deactivated at the base station 105 for power savings. The UE 115 may further receive, from the base station 105, a MAC-CE according to the resource configuration 300 selecting a subset of the A-CSI trigger states. The selected subset of A-CSI trigger states may include A-CSI trigger states associated with the same network power mode or associated with different network power modes. The UE 115 may receive, from the base station 105, DCI indicating an A-CSI trigger state from the MAC-configured sub-selection of A-CSI trigger states.

The UE 115 may determine an A-CSI trigger state from the DCI and may further determine the current network power mode under which the base station 105 is currently operating based on the indicated A-CSI trigger state. That is, the value of the CSI request field in the DCI signaling may carry additional information for the UE 115, such that the UE 115 may determine a current network power mode using the value of the CSI request field (e.g., in addition to the RRC configuration of A-CSI trigger states, the MAC-CE sub-selection of A-CSI trigger states, or both). The UE 115 may determine a quantity of active antenna ports, a configuration of active antenna ports, a quantity of inactive antenna ports, a configuration of inactive antenna ports, or a combination thereof at the base station 105 based on the indicated A-CSI trigger state and the corresponding network power mode. Accordingly, the UE 115 may perform CSI measurements and transmit an A-CSI report to the base station 105 based on the DCI-indicated A-CSI trigger state and the current configuration of active and inactive antennas at the base station 105 corresponding to the base station's current network power mode. For example, the UE 115 may transmit an A-CSI report including CSI associated with a quantity of active antenna ports at the base station 105, effectively managing CSI reporting for dynamic antenna port adaptation at the base station 105. The correlation between A-CSI trigger states and network power modes may ensure that dynamic antenna port adaptation at a base station 105 is supported for network power savings, but is not transparent to a UE 115, such that the UE 115 may perform accurate A-CSI reporting according to the base station's current antenna port configuration.

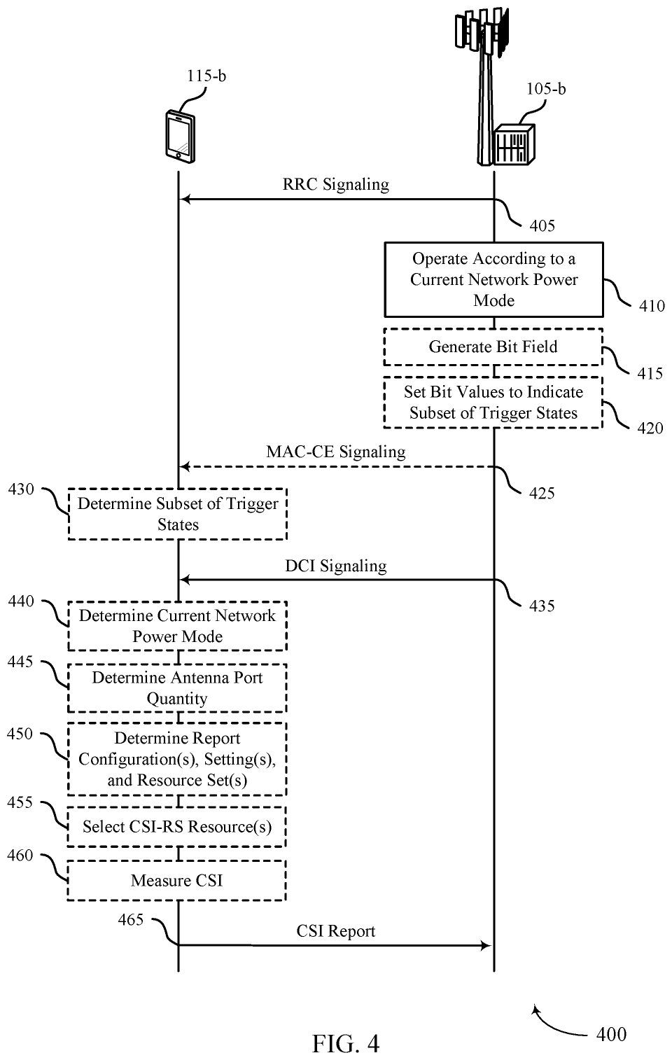

FIG. 4 illustrates an example of a process flow 400 that supports A-CSI reporting for dynamic base station antenna port adaptation in accordance with aspects of the present disclosure. In some examples, the process flow 400 may implement aspects of the wireless communications system 100 and the wireless communications system 200. The process flow 400 may illustrate communications between a UE 115-b and a base station 105-b, which may be examples of a UE 115 and a base station 105 as described with reference to FIGS. 1 and 2. Alternative examples of the following may be implemented, where some processes are performed in a different order than described or are not performed at all. In some examples, processes may include additional features not mentioned below, or further processes may be added.

At 405, the UE 115-b may receive, from the base station 105-b, first control signaling configuring a set of multiple A-CSI trigger states. The set of multiple A-CSI trigger states may include at least a first trigger state for a first network power mode and a second trigger state for a second network power mode. The second network power mode is different from the first network power mode. For example, the first network power mode may be a normal network power mode and the second network power mode may be a network power saving mode, or both network power modes may be different types of network power saving modes. In some cases, the first control signaling may include RRC signaling.

At 410, the base station 105-b may operate according to a current network power mode. In some cases, the current network power mode may include a normal network power mode with a set of antenna ports active at the base station 105-b, a medium network power mode with a first subset of the set of antenna ports active at the base station 105-b, a low network power mode with a second subset of the first subset of the set of antenna ports active at the base station 105-b, or some other network power mode. In some cases, the base station 105-b operating according to the current network power mode may additionally involve the base station 105-b deactivating a subset of antenna ports, a subset of antenna sub-panels, a subset of antenna panels, or any combination thereof and communicating with the UE 115-b based on the deactivating (e.g., using active antennas after the deactivating is performed).

At 415, the base station 105-b may generate a bit field for third control signaling (e.g., an A-CSI trigger state sub-selection MAC-CE), where each trigger state of the set of multiple A-CSI trigger states corresponds to a respective bit of the bit field. For example, one or more bits of the bit field may correspond to a trigger state for a normal network power mode. Similarly, one or more bits of the bit field may correspond to a trigger state for a medium network power mode or a trigger state for a low network power mode. In some cases, a first set of multiple bits of the bit field may correspond to a first set of multiple trigger states of the set of multiple A-CSI trigger states for a normal network power mode and a second set of multiple bits of the bit field may correspond to a second set of multiple trigger states of the set of multiple A-CSI trigger states for one or more network power modes different from the normal network power mode. The bit field may include the bit fields in Oct 2 up to Oct M, as described with reference to FIG. 3. At 420, the base station 105-b may set bit values of the bit field to indicate a subset of the set of multiple A-CSI trigger states. For example, a first bit value may indicate selection of a corresponding A-CSI trigger state, while a second bit value may indicate that the corresponding A-CSI trigger state is not selected.

At 425, the UE 115-b may receive, from the base station 105-b, the third control signaling indicating the subset of the set of multiple A-CSI trigger states. In some cases, the subset of the set of multiple A-CSI trigger states may include at least the first trigger state for the first network power mode and the second trigger state for the second network power mode. In some cases, the third control signaling may include a MAC-CE. At 430, the UE 115-b may determine the subset of the set of multiple A-CSI trigger states based on the bit field of the third control signaling.

At 435, the UE 115-b may receive, from the base station 105-b, second control signaling indicating a trigger state of the set of multiple A-CSI trigger states. The indicated trigger state may indicate a current network power mode of the base station 105-b. The second control signaling may include a DCI. In some cases, the indicated trigger state may indicate the deactivated subset of antenna ports, the deactivated subset of antenna sub-panels, the deactivated subset of antenna panels, or any combination thereof at the base station 105-b. In some cases, the second control signaling may indicate the trigger state from the subset of the set of multiple A-CSI trigger states determined at 430 (e.g., if the UE 115-b received the third control signaling at 425). As an example, the base station 105-b may configure the UE 115-b with eighty A-CSI trigger states using the RRC signaling, may select three A-CSI trigger states out of the eighty A-CSI trigger states using the MAC-CE, and may indicate one A-CSI trigger state out of the three selected A-CSI trigger states using the DCI to trigger A-CSI reporting at the UE 115-b.

At 440, the UE 115-b may determine the current network power mode of the base station 105-b in response to receiving the second control signaling indicating the trigger state. In some cases, the current network power mode of the base station 105-b may be a normal network power mode, a medium network power mode, or a low network power mode.

At 445, the UE 115-b may determine a quantity of antenna ports active at the base station 105-b based on the current network power mode of the base station 105-b. In some cases, a CSI report is based on the quantity of the antenna ports active at the base station 105-b. The antenna ports active at the base station 105-b may include a subset of antenna ports of the base station 105-b based on the current network power mode corresponding to a lower power than a normal network power mode of the base station 105-b.

At 450, the UE 115-b may determine one or more report configurations based on the indicated trigger state. The UE 115-b may determine one or more CSI-RS resource settings active for the one or more report configurations. The UE 115-b may determine one or more CSI-RS resource sets configured for the one or more CSI-RS resource settings.

At 455, the UE 115-b may select one or more CSI-RS resources of the one or more CSI-RS resource sets. In some cases, the CSI report includes a CRI indicating the selected one or more CSI-RS resources. At 460, the UE 115-b may measure the CSI using the selected one or more CSI-RS resources. In some cases, the CSI report may indicate the measured CSI. At 465, the UE 115-b may transmit, to the base station 105-b, the CSI report based on the indicated trigger state and the current network power mode of the base station 105-b.

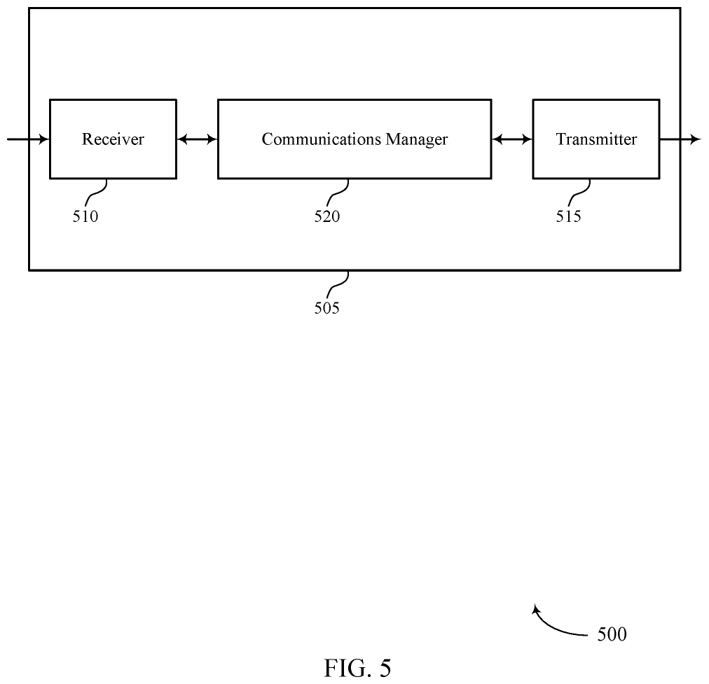

FIG. 5 shows a block diagram 500 of a device 505 that supports A-CSI reporting for dynamic base station antenna port adaptation in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to A-CSI reporting for dynamic base station antenna port adaptation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to A-CSI reporting for dynamic base station antenna port adaptation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of A-CSI reporting for dynamic base station antenna port adaptation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The communications manager 520 may be configured as or otherwise support a means for receiving, from the base station, second control signaling indicating a trigger state of the set of multiple A-CSI trigger states, the indicated trigger state further indicating a current network power mode of the base station. The communications manager 520 may be configured as or otherwise support a means for transmitting, to the base station, a CSI report based on the indicated trigger state and the current network power mode of the base station.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced power consumption, more efficient utilization of communication resources, and improved coordination between devices. For example, the device 505 may support reduced power consumption associated with disabling one or more antenna ports. The techniques for reduced power consumption may allow the device 505 to reducing the processing overhead at the device 505 and more efficiently perform CSI measurement and reporting processes. Additionally or alternatively, techniques described herein may support an increased MAC-CE payload for the device 505, which may improve data throughput and reduce an amount of time that the processing units of the device 505 remain powered on for handling wireless communications, further reducing the processing overhead at the device 505.

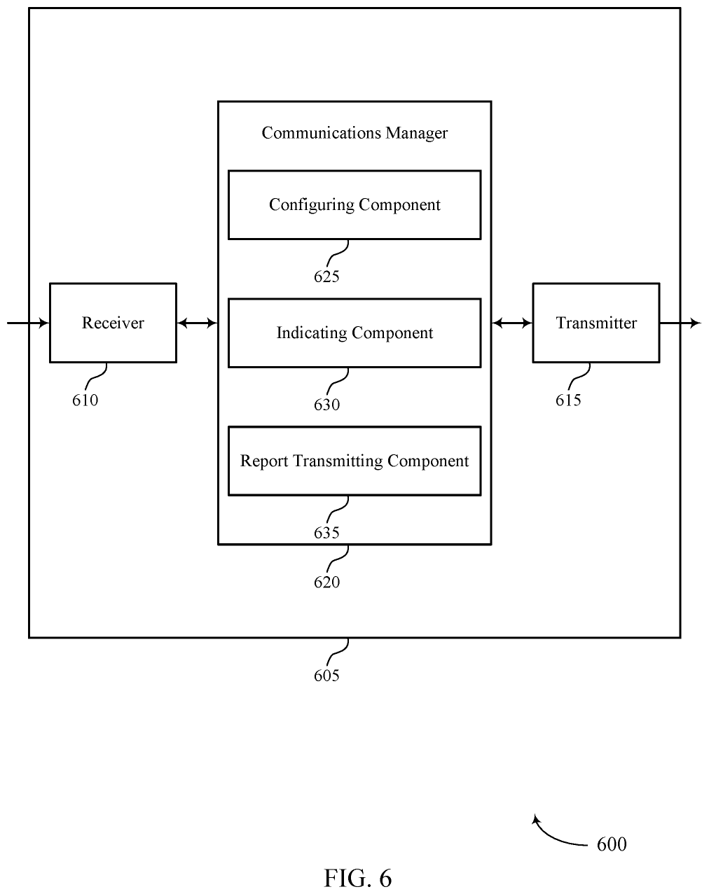

FIG. 6 shows a block diagram 600 of a device 605 that supports A-CSI reporting for dynamic base station antenna port adaptation in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to A-CSI reporting for dynamic base station antenna port adaptation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to A-CSI reporting for dynamic base station antenna port adaptation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of A-CSI reporting for dynamic base station antenna port adaptation as described herein. For example, the communications manager 620 may include a configuring component 625, an indicating component 630, a report transmitting component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The configuring component 625 may be configured as or otherwise support a means for receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The indicating component 630 may be configured as or otherwise support a means for receiving, from the base station, second control signaling indicating a trigger state of the set of multiple A-CSI trigger states, the indicated trigger state further indicating a current network power mode of the base station. The report transmitting component 635 may be configured as or otherwise support a means for transmitting, to the base station, a CSI report based on the indicated trigger state and the current network power mode of the base station.

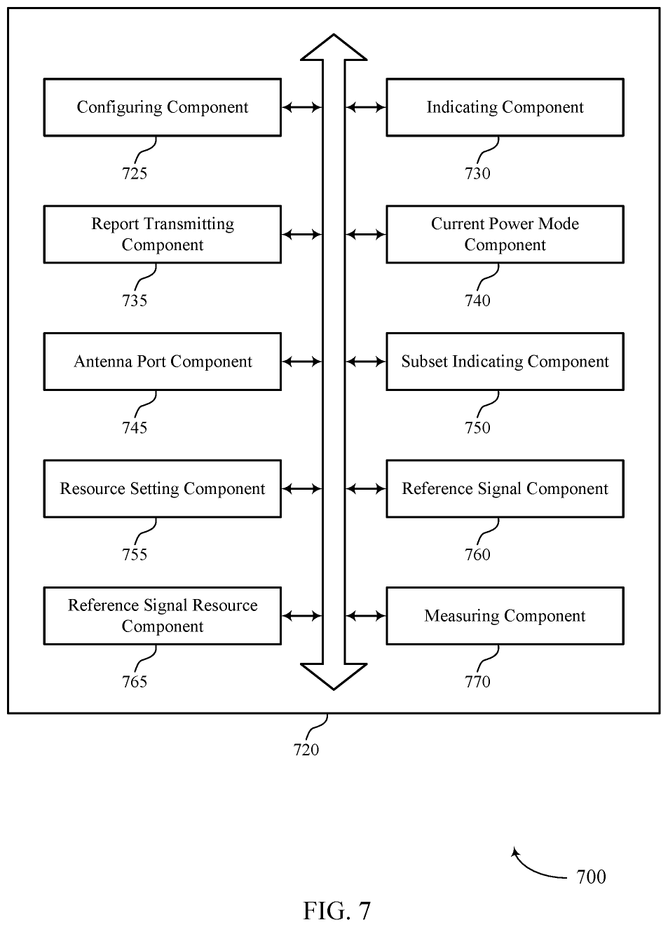

FIG. 7 shows a block diagram 700 of a communications manager 720 that supports A-CSI reporting for dynamic base station antenna port adaptation in accordance with aspects of the present disclosure. The communications manager 720 may be an example of aspects of a communications manager 520, a communications manager 620, or both, as described herein. The communications manager 720, or various components thereof, may be an example of means for performing various aspects of A-CSI reporting for dynamic base station antenna port adaptation as described herein. For example, the communications manager 720 may include a configuring component 725, an indicating component 730, a report transmitting component 735, a current power mode component 740, an antenna port component 745, a subset indicating component 750, a resource setting component 755, a reference signal component 760, a reference signal resource component 765, a measuring component 770, or any combination thereof. Each of these components may communicate, directly or indirectly, with one another (e.g., via one or more buses).

The communications manager 720 may support wireless communications at a UE in accordance with examples as disclosed herein. The configuring component 725 may be configured as or otherwise support a means for receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The indicating component 730 may be configured as or otherwise support a means for receiving, from the base station, second control signaling indicating a trigger state of the set of multiple A-CSI trigger states, the indicated trigger state further indicating a current network power mode of the base station. The report transmitting component 735 may be configured as or otherwise support a means for transmitting, to the base station, a CSI report based on the indicated trigger state and the current network power mode of the base station.

In some examples, the current power mode component 740 may be configured as or otherwise support a means for determining the current network power mode of the base station in response to receiving the second control signaling indicating the trigger state.

In some examples, the antenna port component 745 may be configured as or otherwise support a means for determining a quantity of antenna ports active at the base station based on the current network power mode of the base station, where the CSI report is based on the quantity of the antenna ports active at the base station.

In some examples, the antenna ports active at the base station include a subset of antenna ports of the base station based on the current network power mode corresponding to a lower power than a normal network power mode of the base station.

In some examples, the subset indicating component 750 may be configured as or otherwise support a means for receiving, from the base station, third control signaling indicating a subset of the set of multiple A-CSI trigger states, where the second control signaling indicates the trigger state from the subset of the set of multiple A-CSI trigger states.

In some examples, the subset indicating component 750 may be configured as or otherwise support a means for determining the subset of the set of multiple A-CSI trigger states based on a bit field of the third control signaling, where each trigger state of the set of multiple A-CSI trigger states corresponds to a respective bit of the bit field.

In some examples, a first set of multiple bits of the bit field correspond to a first set of multiple trigger states of the set of multiple A-CSI trigger states corresponding to a normal network power mode. In some examples, a second set of multiple bits of the bit field correspond to a second set of multiple trigger states of the set of multiple A-CSI trigger states corresponding to one or more network power modes different from the normal network power mode.

In some examples, the subset of the set of multiple A-CSI trigger states includes at least the first trigger state corresponding to the first network power mode and the second trigger state corresponding to the second network power mode.

In some examples, the third control signaling includes a MAC-CE. In some examples, the first control signaling includes RRC signaling. In some examples, the second control signaling includes DCI.

In some examples, the current network power mode of the base station includes a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

In some examples, the indicating component 730 may be configured as or otherwise support a means for determining one or more report configurations based on the indicated trigger state. In some examples, the resource setting component 755 may be configured as or otherwise support a means for determining one or more CSI-RS resource settings active for the one or more report configurations. In some examples, the reference signal component 760 may be configured as or otherwise support a means for determining one or more CSI-RS resource sets configured for the one or more CSI-RS resource settings. In some examples, the reference signal resource component 765 may be configured as or otherwise support a means for selecting one or more CSI-RS resources of the one or more CSI-RS resource sets, where the CSI report includes a CRI indicating the selected one or more CSI-RS resources.

In some examples, the measuring component 770 may be configured as or otherwise support a means for measuring CSI using the selected one or more CSI-RS resources, where the CSI report indicates the measured CSI.

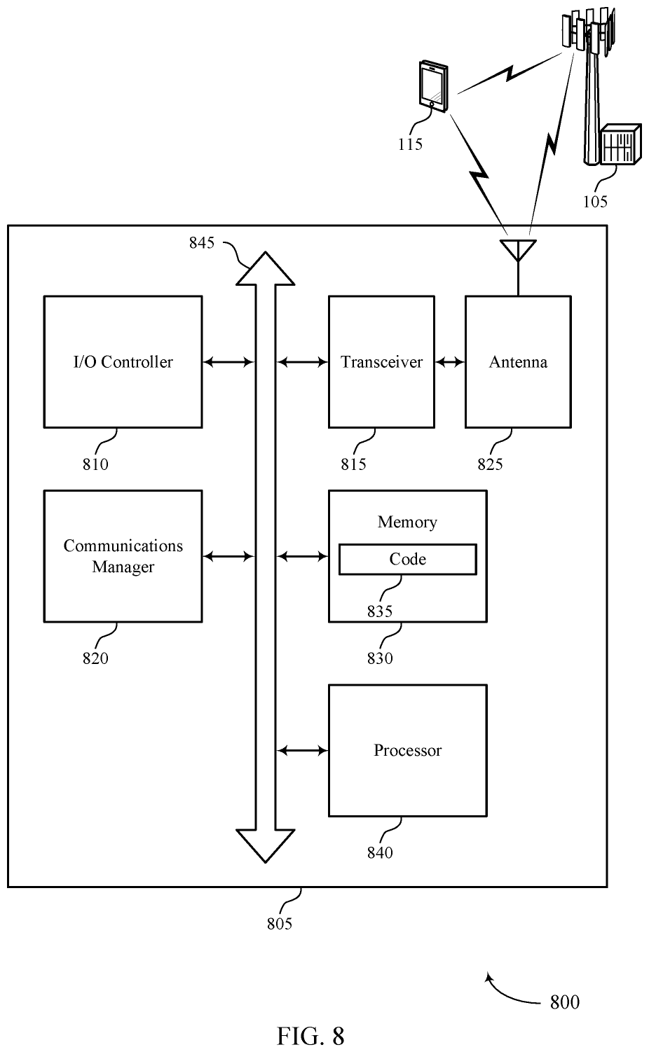

FIG. 8 shows a diagram of a system 800 including a device 805 that supports A-CSI reporting for dynamic base station antenna port adaptation in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting A-CSI reporting for dynamic base station antenna port adaptation). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The communications manager 820 may be configured as or otherwise support a means for receiving, from the base station, second control signaling indicating a trigger state of the set of multiple A-CSI trigger states, the indicated trigger state further indicating a current network power mode of the base station. The communications manager 820 may be configured as or otherwise support a means for transmitting, to the base station, a CSI report based on the indicated trigger state and the current network power mode of the base station.

By including or configuring the communications manager 820 in accordance with examples as described herein, the device 805 may support techniques for reduced power consumption, more efficient utilization of communication resources, and improved coordination between devices. For example, the device 805 may support reduced power consumption associated with disabling one or more antenna ports. The techniques for reduced power consumption may allow the device 805 to reduce the processing overhead at the device 805 and more efficiently perform CSI measurement and reporting processes. Additionally or alternatively, techniques described herein may support an increased MAC-CE payload for the device 805, which may improve data throughput and reduce an amount of time that the processing units of the device 805 remain powered on for handling wireless communications, further reducing the processing overhead at the device 805.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of A-CSI reporting for dynamic base station antenna port adaptation as described herein, or the processor 840 and the memory 830 may be otherwise configured to perform or support such operations.

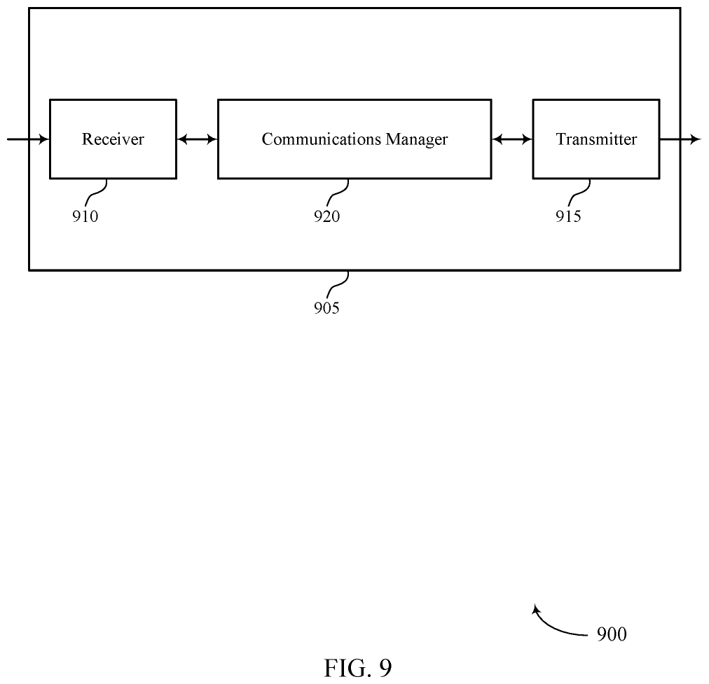

FIG. 9 shows a block diagram 900 of a device 905 that supports A-CSI reporting for dynamic base station antenna port adaptation in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to A-CSI reporting for dynamic base station antenna port adaptation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to A-CSI reporting for dynamic base station antenna port adaptation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of A-CSI reporting for dynamic base station antenna port adaptation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The communications manager 920 may be configured as or otherwise support a means for operating according to a current network power mode. The communications manager 920 may be configured as or otherwise support a means for transmitting, to the UE, second control signaling indicating a trigger state of the set of multiple A-CSI trigger states, the indicated trigger state further indicating the current network power mode. The communications manager 920 may be configured as or otherwise support a means for receiving, from the UE, a CSI report based on the indicated trigger state and the current network power mode.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced power consumption, more efficient utilization of communication resources, and improved coordination between devices. For example, the device 905 may support reduced power consumption associated with disabling one or more antenna ports. The techniques for reduced power consumption may allow the device 905 to reducing the processing overhead at the device 905 and more efficiently receive CSI reporting. Additionally or alternatively, techniques described herein may support an increased MAC-CE payload for the device 905, which may improve data throughput and reduce an amount of time that the processing units of the device 905 remain powered on for handling wireless communications, further reducing the processing overhead at the device 905.

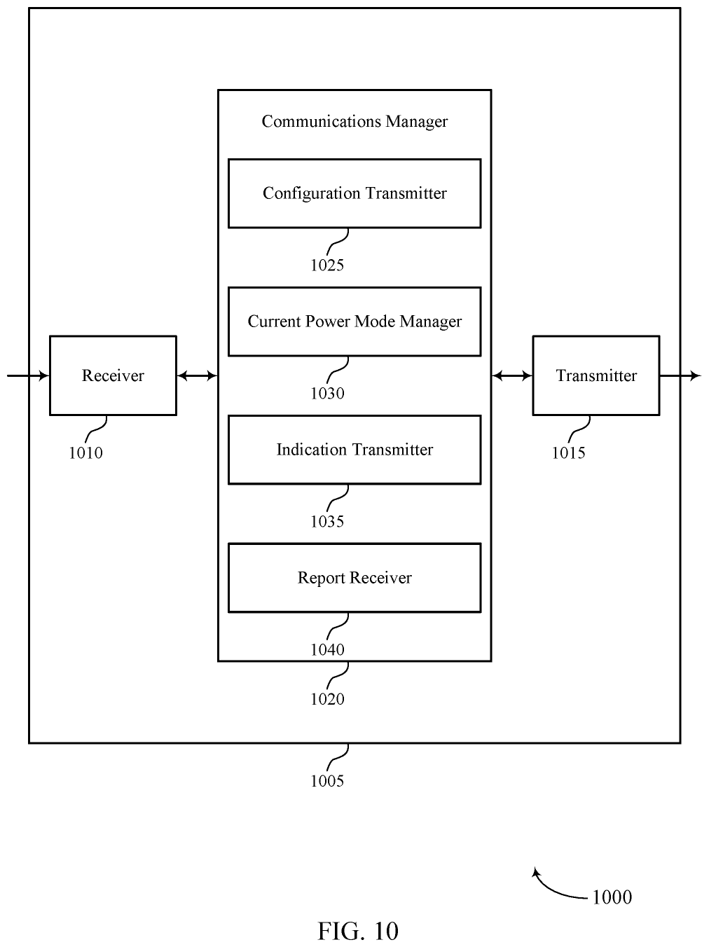

FIG. 10 shows a block diagram 1000 of a device 1005 that supports A-CSI reporting for dynamic base station antenna port adaptation in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to A-CSI reporting for dynamic base station antenna port adaptation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to A-CSI reporting for dynamic base station antenna port adaptation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of A-CSI reporting for dynamic base station antenna port adaptation as described herein. For example, the communications manager 1020 may include a configuration transmitter 1025, a current power mode manager 1030, an indication transmitter 1035, a report receiver 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The configuration transmitter 1025 may be configured as or otherwise support a means for transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The current power mode manager 1030 may be configured as or otherwise support a means for operating according to a current network power mode. The indication transmitter 1035 may be configured as or otherwise support a means for transmitting, to the UE, second control signaling indicating a trigger state of the set of multiple A-CSI trigger states, the indicated trigger state further indicating the current network power mode. The report receiver 1040 may be configured as or otherwise support a means for receiving, from the UE, a CSI report based on the indicated trigger state and the current network power mode.

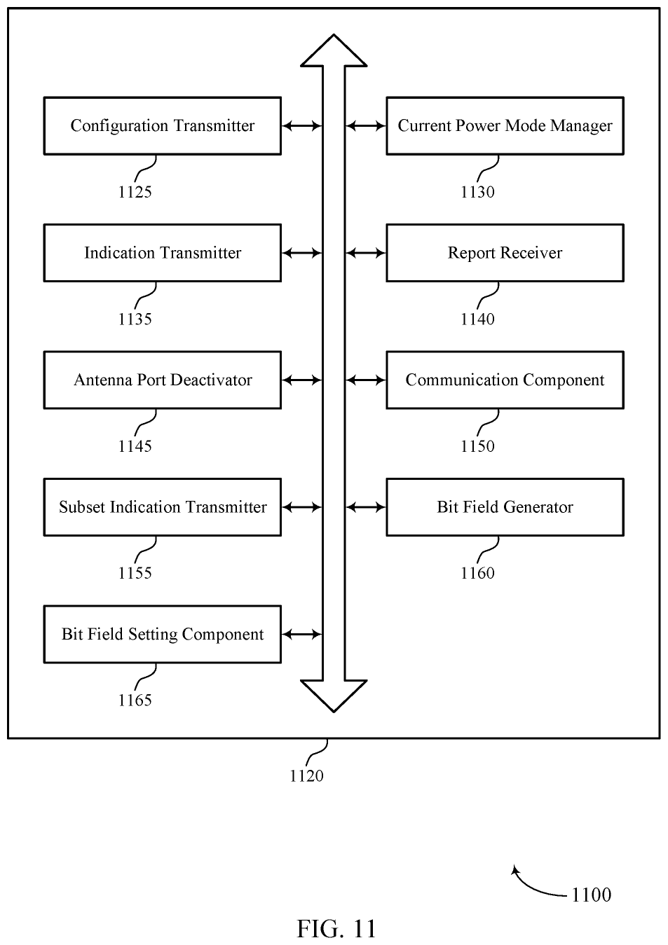

FIG. 11 shows a block diagram 1100 of a communications manager 1120 that supports A-CSI reporting for dynamic base station antenna port adaptation in accordance with aspects of the present disclosure. The communications manager 1120 may be an example of aspects of a communications manager 920, a communications manager 1020, or both, as described herein. The communications manager 1120, or various components thereof, may be an example of means for performing various aspects of A-CSI reporting for dynamic base station antenna port adaptation as described herein. For example, the communications manager 1120 may include a configuration transmitter 1125, a current power mode manager 1130, an indication transmitter 1135, a report receiver 1140, an antenna port deactivator 1145, a communication component 1150, a subset indication transmitter 1155, a bit field generator 1160, a bit field setting component 1165, or any combination thereof. Each of these components may communicate, directly or indirectly, with one another (e.g., via one or more buses).

The communications manager 1120 may support wireless communications at a base station in accordance with examples as disclosed herein. The configuration transmitter 1125 may be configured as or otherwise support a means for transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The current power mode manager 1130 may be configured as or otherwise support a means for operating according to a current network power mode. The indication transmitter 1135 may be configured as or otherwise support a means for transmitting, to the UE, second control signaling indicating a trigger state of the set of multiple A-CSI trigger states, the indicated trigger state further indicating the current network power mode. The report receiver 1140 may be configured as or otherwise support a means for receiving, from the UE, a CSI report based on the indicated trigger state and the current network power mode.

In some examples, to support operating according to the current network power mode, the antenna port deactivator 1145 may be configured as or otherwise support a means for deactivating a subset of antenna ports, a subset of antenna sub-panels, a subset of antenna panels, or any combination thereof. In some examples, to support operating according to the current network power mode, the communication component 1150 may be configured as or otherwise support a means for communicating with the UE based on the deactivating.

In some examples, the indicated trigger state further indicates the deactivated subset of antenna ports, the deactivated subset of antenna sub-panels, the deactivated subset of antenna panels, or any combination thereof.

In some examples, the subset indication transmitter 1155 may be configured as or otherwise support a means for transmitting, to the UE, third control signaling indicating a subset of the set of multiple A-CSI trigger states, where the second control signaling indicates the trigger state from the subset of the set of multiple A-CSI trigger states.

In some examples, the bit field generator 1160 may be configured as or otherwise support a means for generating a bit field for the third control signaling, where each trigger state of the set of multiple A-CSI trigger states corresponds to a respective bit of the bit field. In some examples, the bit field setting component 1165 may be configured as or otherwise support a means for setting bit values of the bit field to indicate the subset of the set of multiple A-CSI trigger states.

In some examples, a first set of multiple bits of the bit field correspond to a first set of multiple trigger states of the set of multiple A-CSI trigger states corresponding to a normal network power mode. In some examples, a second set of multiple bits of the bit field correspond to a second set of multiple trigger states of the set of multiple A-CSI trigger states corresponding to one or more network power modes different from the normal network power mode.

In some examples, the subset of the set of multiple A-CSI trigger states includes at least the first trigger state corresponding to the first network power mode and the second trigger state corresponding to the second network power mode.

In some examples, the third control signaling includes a MAC-CE. In some examples, the first control signaling includes RRC signaling. In some examples, the second control signaling includes DCI.

In some examples, the current network power mode includes a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

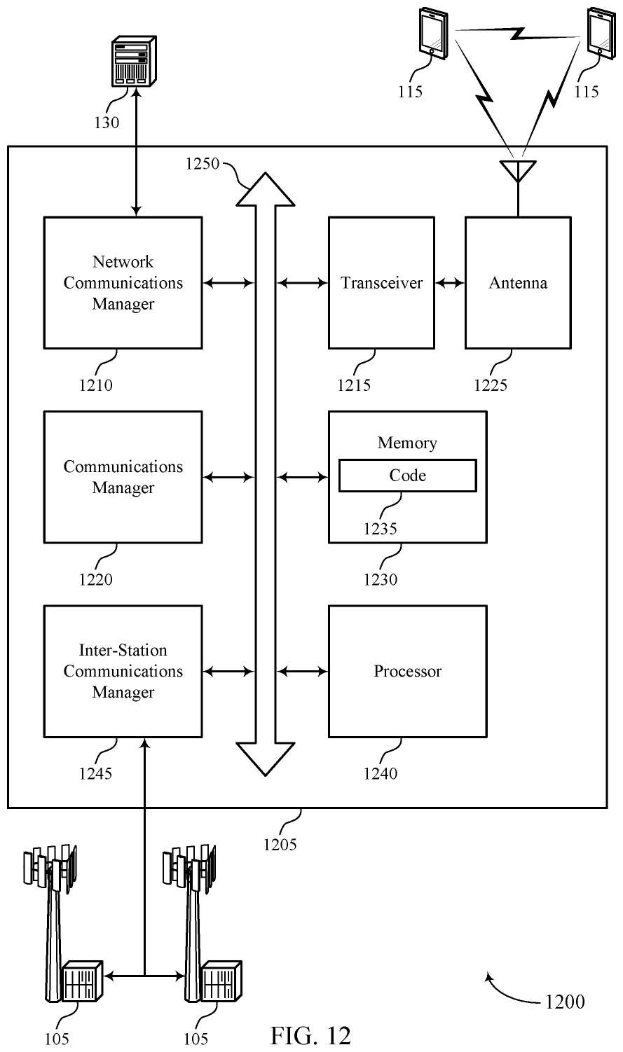

FIG. 12 shows a diagram of a system 1200 including a device 1205 that supports A-CSI reporting for dynamic base station antenna port adaptation in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting A-CSI reporting for dynamic base station antenna port adaptation). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The communications manager 1220 may be configured as or otherwise support a means for operating according to a current network power mode. The communications manager 1220 may be configured as or otherwise support a means for transmitting, to the UE, second control signaling indicating a trigger state of the set of multiple A-CSI trigger states, the indicated trigger state further indicating the current network power mode. The communications manager 1220 may be configured as or otherwise support a means for receiving, from the UE, a CSI report based on the indicated trigger state and the current network power mode.

By including or configuring the communications manager 1220 in accordance with examples as described herein, the device 1205 may support techniques for reduced power consumption, more efficient utilization of communication resources, and improved coordination between devices. For example, the device 1205 may support reduced power consumption associated with disabling one or more antenna ports (e.g., deactivating one or more antennas 1225) at the device 1205. The techniques for reduced power consumption may allow the device 1205 to reduce the processing overhead at the device 1205 and more efficiently perform CSI processes. Additionally or alternatively, techniques described herein may support an increased MAC-CE payload for the device 1205, which may improve data throughput and reduce an amount of time that the processing units of the device 1205 remain powered on for handling wireless communications, further reducing the processing overhead at the device 1205.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of A-CSI reporting for dynamic base station antenna port adaptation as described herein, or the processor 1240 and the memory 1230 may be otherwise configured to perform or support such operations.

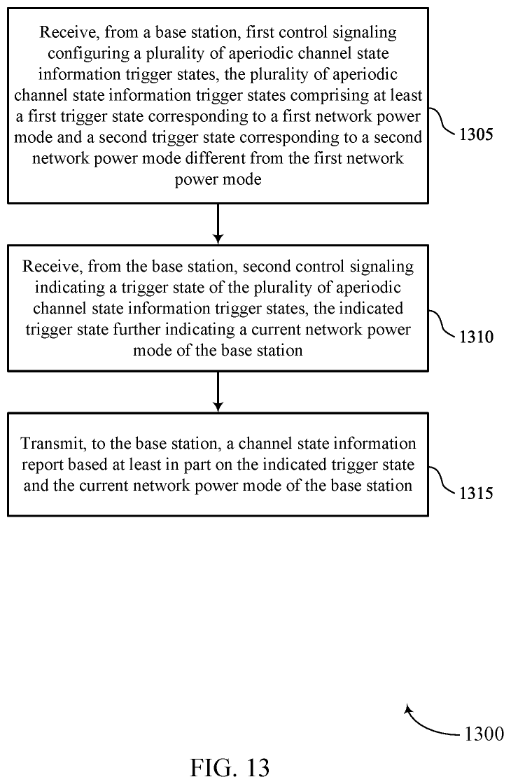

FIG. 13 shows a flowchart illustrating a method 1300 that supports A-CSI reporting for dynamic base station antenna port adaptation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The operations of 1305 may be performed in accordance with examples as disclosed herein. In some examples, aspects of the operations of 1305 may be performed by a configuring component 725 as described with reference to FIG. 7.

At 1310, the method may include receiving, from the base station, second control signaling indicating a trigger state of the set of multiple A-CSI trigger states, the indicated trigger state further indicating a current network power mode of the base station. The operations of 1310 may be performed in accordance with examples as disclosed herein. In some examples, aspects of the operations of 1310 may be performed by an indicating component 730 as described with reference to FIG. 7.

At 1315, the method may include transmitting, to the base station, a CSI report based on the indicated trigger state and the current network power mode of the base station. The operations of 1315 may be performed in accordance with examples as disclosed herein. In some examples, aspects of the operations of 1315 may be performed by a report transmitting component 735 as described with reference to FIG. 7.

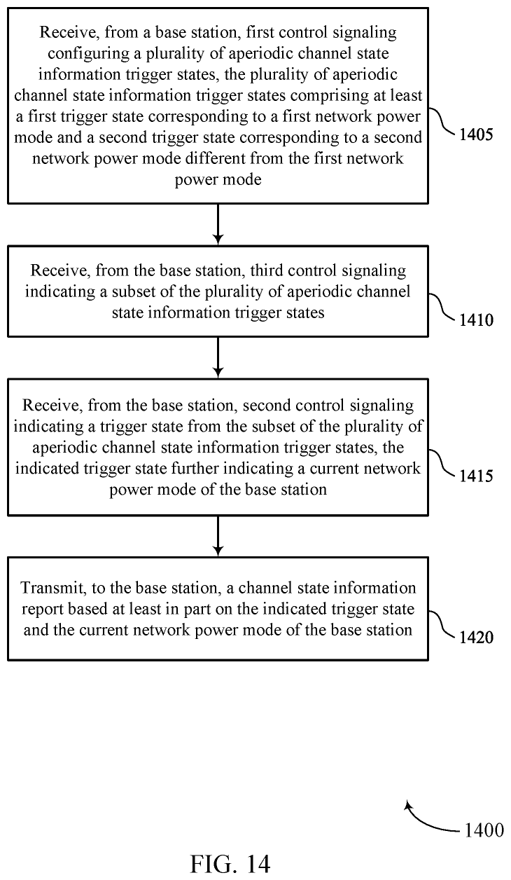

FIG. 14 shows a flowchart illustrating a method 1400 that supports A-CSI reporting for dynamic base station antenna port adaptation in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, first control signaling configuring a set of multiple A-CSI trigger states, the set of multiple A-CSI trigger states including at least a first trigger state corresponding to a first network power mode and a second trigger state corresponding to a second network power mode different from the first network power mode. The operations of 1405 may be performed in accordance with examples as disclosed herein. In some examples, aspects of the operations of 1405 may be performed by a configuring component 725 as described with reference to FIG. 7.

At 1410, the method may include receiving, from the base station, third control signaling indicating a subset of the set of multiple A-CSI trigger states. The operations of 1410 may be performed in accordance with examples as disclosed herein. In some examples, aspects of the operations of 1410 may be performed by a subset indicating component 750 as described with reference to FIG. 7.

At 1415, the method may include receiving, from the base station, second control signaling indicating a trigger state from the subset of the set of multiple A-CSI trigger states, the indicated trigger state further indicating a current network power mode of the base station. The operations of 1415 may be performed in accordance with examples as disclosed herein. In some examples, aspects of the operations of 1415 may be performed by an indicating component 730 as described with reference to FIG. 7.

At 1420, the method may include transmitting, to the base station, a CSI report based on the indicated trigger state and the current network power mode of the base station. The operations of 1420 may be performed in accordance with examples as disclosed herein. In some examples, aspects of the operations of 1420 may be performed by a report transmitting component 735 as described with reference to FIG. 7.

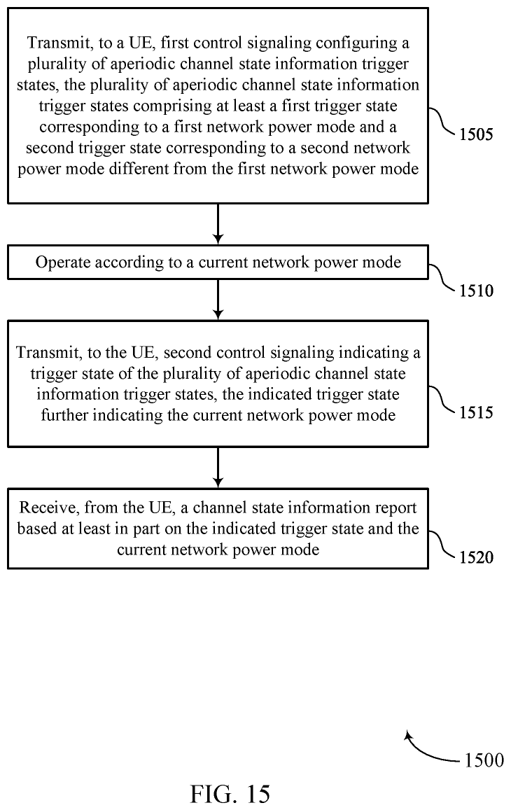

FIG. 15 shows a flowchart illustrating a method 1500 that supports A-CSI reporting for dynamic base station antenna port adaptation in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The operations of 1505 may be performed in accordance with examples as disclosed herein. In some examples, aspects of the operations of 1505 may be performed by a configuration transmitter 1125 as described with reference to FIG. 11.

At 1510, the method may include operating according to a current network power mode. The operations of 1510 may be performed in accordance with examples as disclosed herein. In some examples, aspects of the operations of 1510 may be performed by a current power mode manager 1130 as described with reference to FIG. 11.

At 1515, the method may include transmitting, to the UE, second control signaling indicating a trigger state of the set of multiple A-CSI trigger states, the indicated trigger state further indicating the current network power mode. The operations of 1515 may be performed in accordance with examples as disclosed herein. In some examples, aspects of the operations of 1515 may be performed by an indication transmitter 1135 as described with reference to FIG. 11.

At 1520, the method may include receiving, from the UE, a CSI report based on the indicated trigger state and the current network power mode. The operations of 1520 may be performed in accordance with examples as disclosed herein. In some examples, aspects of the operations of 1520 may be performed by a report receiver 1140 as described with reference to FIG. 11.

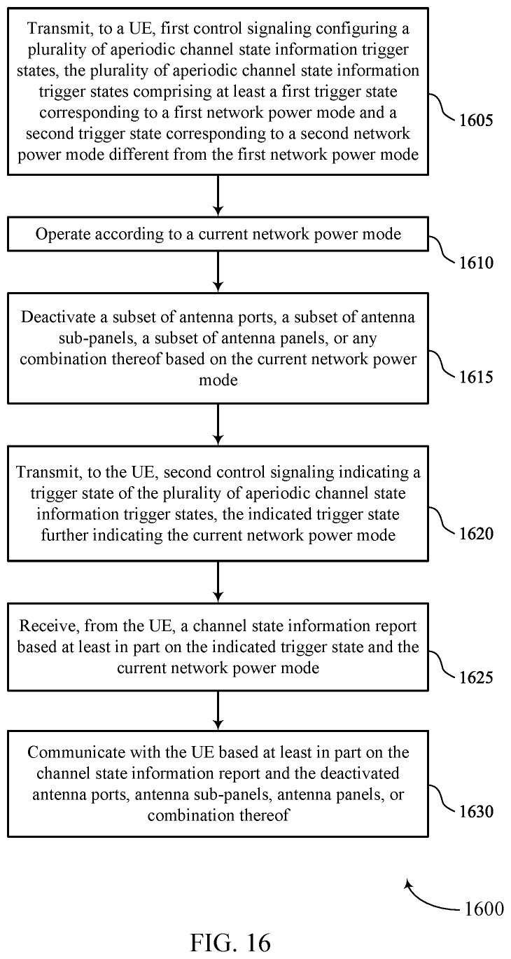

FIG. 16 shows a flowchart illustrating a method 1600 that supports A-CSI reporting for dynamic base station antenna port adaptation in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, first control signaling configuring a set of multiple A-CSI trigger states, the set of multiple A-CSI trigger states including at least a first trigger state corresponding to a first network power mode and a second trigger state corresponding to a second network power mode different from the first network power mode. The operations of 1605 may be performed in accordance with examples as disclosed herein. In some examples, aspects of the operations of 1605 may be performed by a configuration transmitter 1125 as described with reference to FIG. 11.

At 1610, the method may include operating according to a current network power mode. The operations of 1610 may be performed in accordance with examples as disclosed herein. In some examples, aspects of the operations of 1610 may be performed by a current power mode manager 1130 as described with reference to FIG. 11.

At 1615, the method may include deactivating a subset of antenna ports, a subset of antenna sub-panels, a subset of antenna panels, or any combination thereof based on the current network power mode. The operations of 1615 may be performed in accordance with examples as disclosed herein. In some examples, aspects of the operations of 1615 may be performed by an antenna port deactivator 1145 as described with reference to FIG. 11.

At 1620, the method may include transmitting, to the UE, second control signaling indicating a trigger state of the set of multiple A-CSI trigger states, the indicated trigger state further indicating the current network power mode. The operations of 1620 may be performed in accordance with examples as disclosed herein. In some examples, aspects of the operations of 1620 may be performed by an indication transmitter 1135 as described with reference to FIG. 11.

At 1625, the method may include receiving, from the UE, a CSI report based on the indicated trigger state and the current network power mode. The operations of 1625 may be performed in accordance with examples as disclosed herein. In some examples, aspects of the operations of 1625 may be performed by a report receiver 1140 as described with reference to FIG. 11.

At 1630, the method may include communicating with the UE based on the CSI report and the deactivating at 1615. The operations of 1630 may be performed in accordance with examples as disclosed herein. In some examples, aspects of the operations of 1630 may be performed by a communication component 1150 as described with reference to FIG. 11.

The following provides an overview of aspects of the present disclosure:

Aspect 1: A method for wireless communications at a UE, comprising: receiving, from a base station, first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode; receiving, from the base station, second control signaling indicating a trigger state of the plurality of aperiodic channel state information trigger states, the indicated trigger state further indicating a current network power mode of the base station; and transmitting, to the base station, a channel state information report based at least in part on the indicated trigger state and the current network power mode of the base station.

Aspect 2: The method of aspect 1, further comprising: determining the current network power mode of the base station in response to receiving the second control signaling indicating the trigger state.

Aspect 3: The method of any of aspects 1 through 2, further comprising: determining a quantity of antenna ports active at the base station based at least in part on the current network power mode of the base station, wherein the channel state information report is based at least in part on the quantity of the antenna ports active at the base station.

Aspect 4: The method of aspect 3, wherein the antenna ports active at the base station comprise a subset of antenna ports of the base station based at least in part on the current network power mode corresponding to a lower power than a normal network power mode of the base station.

Aspect 5: The method of any of aspects 1 through 4, further comprising: receiving, from the base station, third control signaling indicating a subset of the plurality of aperiodic channel state information trigger states, wherein the second control signaling indicates the trigger state from the subset of the plurality of aperiodic channel state information trigger states.

Aspect 6: The method of aspect 5, further comprising: determining the subset of the plurality of aperiodic channel state information trigger states based at least in part on a bit field of the third control signaling, wherein each trigger state of the plurality of aperiodic channel state information trigger states corresponds to a respective bit of the bit field.

Aspect 7: The method of aspect 6, wherein a first plurality of bits of the bit field correspond to a first plurality of trigger states of the plurality of aperiodic channel state information trigger states corresponding to a normal network power mode; and a second plurality of bits of the bit field correspond to a second plurality of trigger states of the plurality of aperiodic channel state information trigger states corresponding to one or more network power modes different from the normal network power mode.

Aspect 8: The method of any of aspects 5 through 7, wherein the subset of the plurality of aperiodic channel state information trigger states comprises at least the first trigger state corresponding to the first network power mode and the second trigger state corresponding to the second network power mode.

Aspect 9: The method of any of aspects 5 through 8, wherein the third control signaling comprises a medium access control element.

Aspect 10: The method of any of aspects 1 through 9, wherein the first control signaling comprises radio resource control signaling; and the second control signaling comprises downlink control information.

Aspect 11: The method of any of aspects 1 through 10, wherein the current network power mode of the base station comprises a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

Aspect 12: The method of any of aspects 1 through 11, further comprising: determining one or more report configurations based at least in part on the indicated trigger state; determining one or more channel state information reference signal resource settings active for the one or more report configurations; determining one or more channel state information reference signal resource sets configured for the one or more channel state information reference signal resource settings; and selecting one or more channel state information reference signal resources of the one or more channel state information reference signal resource sets, wherein the channel state information report comprises a channel state information reference signal resource indicator indicating the selected one or more channel state information reference signal resources.

Aspect 13: The method of aspect 12, further comprising: measuring channel state information using the selected one or more channel state information reference signal resources, wherein the channel state information report indicates the measured channel state information.

Aspect 14: A method for wireless communications at a base station, comprising: transmitting, to a UE, first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode; operating according to a current network power mode; transmitting, to the UE, second control signaling indicating a trigger state of the plurality of aperiodic channel state information trigger states, the indicated trigger state further indicating the current network power mode; and receiving, from the UE, a channel state information report based at least in part on the indicated trigger state and the current network power mode.

Aspect 15: The method of aspect 14, wherein operating according to the current network power mode further comprises: deactivating a subset of antenna ports, a subset of antenna sub-panels, a subset of antenna panels, or any combination thereof; and communicating with the UE based at least in part on the deactivating.

Aspect 16: The method of aspect 15, wherein the indicated trigger state further indicates the deactivated subset of antenna ports, the deactivated subset of antenna sub-panels, the deactivated subset of antenna panels, or any combination thereof.

Aspect 17: The method of any of aspects 14 through 16, further comprising: transmitting, to the UE, third control signaling indicating a subset of the plurality of aperiodic channel state information trigger states, wherein the second control signaling indicates the trigger state from the subset of the plurality of aperiodic channel state information trigger states.

Aspect 18: The method of aspect 17, further comprising: generating a bit field for the third control signaling, wherein each trigger state of the plurality of aperiodic channel state information trigger states corresponds to a respective bit of the bit field; and setting bit values of the bit field to indicate the subset of the plurality of aperiodic channel state information trigger states.

Aspect 19: The method of aspect 18, wherein a first plurality of bits of the bit field correspond to a first plurality of trigger states of the plurality of aperiodic channel state information trigger states corresponding to a normal network power mode; and a second plurality of bits of the bit field correspond to a second plurality of trigger states of the plurality of aperiodic channel state information trigger states corresponding to one or more network power modes different from the normal network power mode.

Aspect 20: The method of any of aspects 17 through 19, wherein the subset of the plurality of aperiodic channel state information trigger states comprises at least the first trigger state corresponding to the first network power mode and the second trigger state corresponding to the second network power mode.

Aspect 21: The method of any of aspects 17 through 20, wherein the third control signaling comprises a medium access control element.

Aspect 22: The method of any of aspects 14 through 21, wherein the first control signaling comprises radio resource control signaling; and the second control signaling comprises downlink control information.

Aspect 23: The method of any of aspects 14 through 22, wherein the current network power mode comprises a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

Aspect 24: An apparatus for wireless communications at a UE, comprising a processor; memory coupled with the processor; and instructions stored in the memory and executable by the processor to cause the apparatus to perform a method of any of aspects 1 through 13.

Aspect 25: An apparatus for wireless communications at a UE, comprising at least one means for performing a method of any of aspects 1 through 13.

Aspect 26: A non-transitory computer-readable medium storing code for wireless communications at a UE, the code comprising instructions executable by a processor to perform a method of any of aspects 1 through 13.

Aspect 27: An apparatus for wireless communications at a base station, comprising a processor; memory coupled with the processor; and instructions stored in the memory and executable by the processor to cause the apparatus to perform a method of any of aspects 14 through 23.

Aspect 28: An apparatus for wireless communications at a base station, comprising at least one means for performing a method of any of aspects 14 through 23.

Aspect 29: A non-transitory computer-readable medium storing code for wireless communications at a base station, the code comprising instructions executable by a processor to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode;
receiving, from the base station, second control signaling indicating a trigger state of the plurality of aperiodic channel state information trigger states, the indicated trigger state further indicating a current network power mode of the base station; and
transmitting, to the base station, a channel state information report based at least in part on the indicated trigger state and the current network power mode of the base station.

2. The method of claim 1, further comprising:
determining the current network power mode of the base station in response to receiving the second control signaling indicating the trigger state.

3. The method of claim 1, further comprising:
determining a quantity of antenna ports active at the base station based at least in part on the current network power mode of the base station, wherein the channel state information report is based at least in part on the quantity of the antenna ports active at the base station.

4. The method of claim 3, wherein the antenna ports active at the base station comprise a subset of antenna ports of the base station based at least in part on the current network power mode corresponding to a lower power than a normal network power mode of the base station.

5. The method of claim 1, further comprising:
receiving, from the base station, third control signaling indicating a subset of the plurality of aperiodic channel state information trigger states, wherein the second control signaling indicates the trigger state from the subset of the plurality of aperiodic channel state information trigger states.

6. The method of claim 5, further comprising:
determining the subset of the plurality of aperiodic channel state information trigger states based at least in part on a bit field of the third control signaling, wherein each trigger state of the plurality of aperiodic channel state information trigger states corresponds to a respective bit of the bit field.

7. The method of claim 6, wherein:
a first plurality of bits of the bit field correspond to a first plurality of trigger states of the plurality of aperiodic channel state information trigger states corresponding to a normal network power mode; and
a second plurality of bits of the bit field correspond to a second plurality of trigger states of the plurality of aperiodic channel state information trigger states corresponding to one or more network power modes different from the normal network power mode.

8. The method of claim 5, wherein the subset of the plurality of aperiodic channel state information trigger states comprises at least the first trigger state corresponding to the first network power mode and the second trigger state corresponding to the second network power mode.

9. The method of claim 5, wherein the third control signaling comprises a medium access control element.

10. The method of claim 1, wherein:
the first control signaling comprises radio resource control signaling; and
the second control signaling comprises downlink control information.

11. The method of claim 1, wherein the current network power mode of the base station comprises a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

12. The method of claim 1, further comprising:
determining one or more report configurations based at least in part on the indicated trigger state;
determining one or more channel state information reference signal resource settings active for the one or more report configurations;
determining one or more channel state information reference signal resource sets configured for the one or more channel state information reference signal resource settings; and
selecting one or more channel state information reference signal resources of the one or more channel state information reference signal resource sets, wherein the channel state information report comprises a channel state information reference signal resource indicator indicating the selected one or more channel state information reference signal resources.

13. The method of claim 12, further comprising:
measuring channel state information using the selected one or more channel state information reference signal resources, wherein the channel state information report indicates the measured channel state information.

14. A method for wireless communications at a base station, comprising:
transmitting, to a user equipment (UE), first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode;
operating according to a current network power mode;
transmitting, to the UE, second control signaling indicating a trigger state of the plurality of aperiodic channel state information trigger states, the indicated trigger state further indicating the current network power mode; and
receiving, from the UE, a channel state information report based at least in part on the indicated trigger state and the current network power mode.

15. The method of claim 14, wherein operating according to the current network power mode further comprises:
deactivating a subset of antenna ports, a subset of antenna sub-panels, a subset of antenna panels, or any combination thereof, and
communicating with the UE based at least in part on the deactivating.

16. The method of claim 15, wherein the indicated trigger state further indicates the deactivated subset of antenna ports, the deactivated subset of antenna sub-panels, the deactivated subset of antenna panels, or any combination thereof.

17. The method of claim 14, further comprising:
transmitting, to the UE, third control signaling indicating a subset of the plurality of aperiodic channel state information trigger states, wherein the second control signaling indicates the trigger state from the subset of the plurality of aperiodic channel state information trigger states.

18. The method of claim 17, further comprising:
generating a bit field for the third control signaling, wherein each trigger state of the plurality of aperiodic channel state information trigger states corresponds to a respective bit of the bit field; and
setting bit values of the bit field to indicate the subset of the plurality of aperiodic channel state information trigger states.

19. The method of claim 18, wherein:
a first plurality of bits of the bit field correspond to a first plurality of trigger states of the plurality of aperiodic channel state information trigger states corresponding to a normal network power mode; and
a second plurality of bits of the bit field correspond to a second plurality of trigger states of the plurality of aperiodic channel state information trigger states corresponding to one or more network power modes different from the normal network power mode.

20. The method of claim 17, wherein the subset of the plurality of aperiodic channel state information trigger states comprises at least the first trigger state corresponding to the first network power mode and the second trigger state corresponding to the second network power mode.

21. The method of claim 17, wherein the third control signaling comprises a medium access control element.

22. The method of claim 14, wherein:
the first control signaling comprises radio resource control signaling; and
the second control signaling comprises downlink control information.

23. The method of claim 14, wherein the current network power mode comprises a normal network power mode corresponding to a set of antenna ports active at the base station, a medium network power mode corresponding to a first subset of the set of antenna ports active at the base station, or a low network power mode corresponding to a second subset of the first subset of the set of antenna ports active at the base station.

24. An apparatus for wireless communications at a user equipment (UE), comprising:
a processor;
memory coupled with the processor; and
instructions stored in the memory and executable by the processor to cause the apparatus to:
receive, from a base station, first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode;
receive, from the base station, second control signaling indicating a trigger state of the plurality of aperiodic channel state information trigger states, the indicated trigger state further indicating a current network power mode of the base station; and
transmit, to the base station, a channel state information report based at least in part on the indicated trigger state and the current network power mode of the base station.

25. The apparatus of claim 24, wherein the instructions are further executable by the processor to cause the apparatus to:
determine the current network power mode of the base station in response to receiving the second control signaling indicating the trigger state.

26. The apparatus of claim 24, wherein the instructions are further executable by the processor to cause the apparatus to:
determine a quantity of antenna ports active at the base station based at least in part on the current network power mode of the base station, wherein the channel state information report is based at least in part on the quantity of the antenna ports active at the base station.

27. The apparatus of claim 26, wherein the antenna ports active at the base station comprise a subset of antenna ports of the base station based at least in part on the current network power mode corresponding to a lower power than a normal network power mode of the base station.

28. The apparatus of claim 24, wherein the instructions are further executable by the processor to cause the apparatus to:
receive, from the base station, third control signaling indicating a subset of the plurality of aperiodic channel state information trigger states, wherein the second control signaling indicates the trigger state from the subset of the plurality of aperiodic channel state information trigger states.

29. The apparatus of claim 28, wherein the instructions are further executable by the processor to cause the apparatus to:
determine the subset of the plurality of aperiodic channel state information trigger states based at least in part on a bit field of the third control signaling, wherein each trigger state of the plurality of aperiodic channel state information trigger states corresponds to a respective bit of the bit field.

30. An apparatus for wireless communications at a base station, comprising:
a processor;
memory coupled with the processor; and
instructions stored in the memory and executable by the processor to cause the apparatus to:
transmit, to a user equipment (UE), first control signaling configuring a plurality of aperiodic channel state information trigger states, the plurality of aperiodic channel state information trigger states comprising at least a first trigger state corresponding to a first network power mode and a second trigger state corresponding to a second network power mode different from the first network power mode;
operate according to a current network power mode;
transmit, to the UE, second control signaling indicating a trigger state of the plurality of aperiodic channel state information trigger states, the indicated trigger state further indicating the current network power mode; and
receive, from the UE, a channel state information report based at least in part on the indicated trigger state and the current network power mode.
